(19) United States
(12) Patent Application Publication
(10) Pub. No.: US 2024/0356755 A1
(43) Pub. Date: Oct. 24, 2024

(54) COORDINATING PEER-TO-PEER DATA TRANSFER USING BLOCKCHAIN

(71) Applicant: nChain Licensing AG, Zug (CH)

(72) Inventors: Alexandru PAUNOIU, London (GB); Craig Steven WRIGHT, London (GB)

(21) Appl. No.: 18/683,220

(22) PCT Filed: Jul. 19, 2022
(86) PCT No.: PCT/EP2022/070119

§ 371 Date: Feb. 12, 2024

(30) Foreign Application Priority Data
Aug. 18, 2021 (GB) 2111836.9

(51) Int. Cl. H04L 9/32; H04L 9/30

(52) U.S. Cl. CPC H04L 9/3242; H04L 9/30

(57) ABSTRACT

A computer implemented method of using a blockchain to coordinate data transfer over a P2P network. A second hash value is obtained, the second hash value generated by hashing a data request associated with a data item with first and second hash functions. The second hash value and the requesting node's public key are sent to the P2P nodes connected to the requesting node, wherein a chain is formed between the requesting and target nodes. The target node splits the data into packets, uses the requesting node's public key to encrypt each of the packets together with the first hash value to generate first encrypted messages, and generates final encrypted messages by encrypting the first encrypted messages with the public keys of nodes in the chain. The encrypted messages are obtained and decrypted to construct the data item, and submitting attestation transactions to the blockchain.

### CROSS REFERENCE TO RELATED APPLICATIONS

This application is the U.S. National Stage of International Application No. PCT/EP2022/070119, filed on Jul. 19, 2022, which claims the benefit of United Kingdom Patent Application No. 2111836.9, filed on Aug. 18, 2021, the contents of which are incorporated herein by reference in their entireties.

### TECHNICAL FIELD

The present disclosure relates to methods of using a blockchain to coordinate the transfer of data between nodes of a peer-to-peer (P2P) network. The methods enable the attestation of the data transfer.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below.

Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

Peer-to-Peer (P2P) networks have been one of the driving forces in the development of internet communication and information sharing. In particular, since 2009 blockchain networks have been the cryptographic breakthrough in P2P network services. Leading file-sharing services, such as the BitTorrent networks, Kazaa or Gnutella are other examples of well-known P2P networks.

There is a problem with some P2P networks in that they lack trust and security amongst nodes, meaning that there is a reluctance to participate in the transfer of data between nodes of the network. In turn, this can lead to the P2P networks having difficulty scaling.

According to one aspect disclosed herein, there is provided a computer implemented method of using a blockchain to coordinate data transfer over a peer-to-peer, P2P, network, wherein the P2P network comprises a plurality of P2P nodes, wherein each P2P node is connected to at least one other P2P node and is associated with a respective public key, wherein a target one of the P2P nodes has access to a target data item, and wherein the method is performing by a requesting P2P node and comprises: obtaining a second hash value, wherein the second hash value is generated by hashing at least a data request with a first hash function to generate a first hash value and then hashing at least the first hash value with a second hash function to generate the second hash value, wherein the data request is associated with the target data item; sending the second hash value and the requesting P2P node's public key to one or more P2P nodes connected to the requesting P2P node, wherein a chain of P2P nodes is formed between the requesting P2P node and the target P2P node, each P2P node in the chain being connected to a previous P2P node in the chain and/or a next P2P node in the chain, and wherein each P2P node in the chain is configured to send, to the next P2P node in the chain, the second hash value and the respective public key associated with each respective previous P2P node in the chain, such that the target P2P node receives the second hash value and one or more respective public keys; wherein the target P2P node is configured to split the target data item into one or more respective data packets, use the requesting P2P node's public key to encrypt each of the one or more respective data packets together with the first hash value to generate one or more respective first encrypted messages, and generate one or more respective final encrypted messages by encrypting the one or more respective first encrypted messages with each of the received one or more respective public keys, and wherein the method comprises: obtaining the one or more first encrypted messages from the respective P2P node in the chain connected to the requesting P2P node, wherein each respective P2P node in the chain other than the requesting P2P node obtains one or more encrypted messages from the next respective P2P node in the chain, decrypts the one or more encrypted messages using the respective private key associated with the respective P2P node, and sends the one or more encrypted messages to the previous respective P2P node in the chain, such that the one or more final encrypted messages are successively decrypted as they are sent along the chain from the target P2P node to the requesting P2P node;
decrypting the one or more respective first encrypted messages using the requesting P2P node's private key to obtain the one or more respective data packets and constructing the target data item based thereon; and
submitting one or more respective attestation transactions to the blockchain network to attest to obtaining the one or more first encrypted messages from the respective P2P node in the chain connected to the requesting P2P node.

According to another aspect disclosed herein, there is provided a computer implemented method of using a blockchain to coordinate data transfer over a peer-to-peer, P2P, network, wherein the P2P network comprises a plurality of P2P nodes, wherein each P2P node is connected to at least one other P2P node and is associated with a respective public key, wherein a target one of the P2P nodes has access to a target data item requested by a requesting P2P node, wherein the method is performing by the target P2P node and comprises: obtaining a second hash value and one or more public keys, each public key being associated with a respective P2P node, wherein one of the one or more public keys is the requesting P2P node's public key, and wherein each of the other one or more public keys is associated with a respective P2P node belonging to a chain of P2P nodes between the requesting p2P node and the target P2P node, each P2P node in the chain being connected to a previous P2P node in the chain and/or a next P2P node in the chain; determining that the second hash value is based on a first hash value, wherein the first hash value is based on a data request associated with the target data item; splitting the target data item into one or more respective data packets; using the requesting P2P node's public key to encrypt each of the one or more respective data packets together with the first hash value to generate one or more respective first encrypted messages; encrypting the one or more respective first encrypted messages with each of the respective public keys associated with the respective P2P nodes in the chain to generate one or more respective final encrypted messages; and sending the one or more respective final encrypted messages to the P2P node in the chain that is connected to the target P2P node, and wherein one or more respective attestation transactions are submitted to the blockchain network to attest to the sending of the one or more respective final encrypted messages.

The present disclosure utilizes the blockchain to improve the trust and security of P2P networks, particularly during data distribution. The blockchain is used to improve the coordination between P2P nodes so as to increase the efficiency of data transfer. The request for data is sent from the requesting node to the target node via one or more intermediate nodes. The requesting node sends the request to a first intermediate node along with its public key. The first intermediate node forwards the request, the requesting node's public key and its own public key to a second intermediate node (or the target node, if the first intermediate node is connected to the target node). Each intermediate node that receives the request performs the same process of forwarding the request, the received public keys, and its own public key to the next node, until the request is received by the target node. In this way, a chain is formed from the requesting node to the target node via one or more intermediate nodes, wherein each node in the chain is connected to at least one other node in the chain (the requesting node and target node are at the end of the chain and so may only be connected to one other node). The chain of nodes may represent the shortest possible path between the requesting node and the target node.

The target data is encrypted, by the target node, using the respective public key of each node in the chain, other than the target node's public key. This means that each of the nodes in the chain, other than the target node, are required to participate in the decryption of the target data. More specifically, the encrypted target data is sent from the target node to the requesting node along the chain of nodes. Each node in the chain partially decrypts the encrypted target data with its own private key. By the time the encrypted data reaches the requesting node it is only encrypted with the requesting node's public key, and therefore the requesting node can decrypt the encrypted target data to reveal the target data. The requesting node submits an attestation transaction to the blockchain to attest to the receiving of the data. Similarly, each other node may submit attestation transactions to the blockchain to attest to the receiving of the encrypted data from the previous node in the chain.

In some embodiments, the target data is split into one or more chunks before being encrypted and transferred to the requesting node. The transmittal of each data chunks to the requesting node may be attested to on the blockchain.

The transmittal of the (encrypted) target data is therefore recorded on the blockchain (in the form of the attestation transactions), which improves the security of the data transfer process as the identity of each node involved is immutably recorded on the blockchain. In other words, there is a clear and permanent record of where the target data originated from and how it passed to the requesting node. The transfer of the request from the requesting node to the target node may also be recorded (or at least attested to) on the blockchain.

Note that as used herein, any reference to a “P2P network” shall be understood as meaning a P2P network other than the blockchain network, e.g. general P2P computer networks. Any reference to a P2P node shall be understood as meaning a node of the P2P network.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of some node software for processing transactions,

FIG. 5 schematically illustrates an example of a P2P network interacting with a blockchain network,

FIG. 6 schematically illustrates an example transaction used to alert a second node to a connection available with a first node,

FIG. 7 schematically illustrates an example transaction used to alert a second node to a connection available with a first node and detail the first node's specialisms,

FIG. 8 schematically illustrates another example transaction used to alert a second node to a connection available with a first node,

FIG. 9 schematically illustrates an example transaction used to alert a second node that the connection with the first node is unavailable,

FIG. 10 schematically illustrates an example transaction used by a second node to terminate a connection with the first node,

FIG. 11 schematically illustrates an example transaction used to update the first node's specialisms,

FIG. 12 schematically illustrates another example of a P2P network interacting with a blockchain network,

FIG. 13 illustrates an example of a directed acyclic graph with six nodes,

FIG. 14 schematically illustrates an example P2P network with seven nodes, where edges represent direct network connections,

FIG. 15 schematically illustrates an example flow of protocol messages and data transfer according to the Gnutella protocol,

FIG. 16 is a flow diagram showing an example of the Onion routing protocol with three nodes,

FIG. 17 schematically illustrates a P2P node receiving a data transfer and broadcasting an attestation transaction to the blockchain network,

FIG. 18 schematically illustrates an example flow of request transactions forwarding a data request from a requesting node,

FIG. 19 schematically illustrates P2P nodes receive a reward for forwarding the data request and the target node transferring data to the requesting node,

FIG. 20 schematically illustrates an example primary request transaction,

FIG. 21 schematically illustrates an example secondary request transaction,

FIG. 22 schematically illustrates an example response transaction,

FIG. 23 schematically illustrates an example flow of a data request and public keys starting from the requesting node, and

FIG. 24 schematically illustrates an example routing protocol for transferring data to the requesting node.

### DETAILED DESCRIPTION OF EMBODIMENTS

### 1. Example System Overview

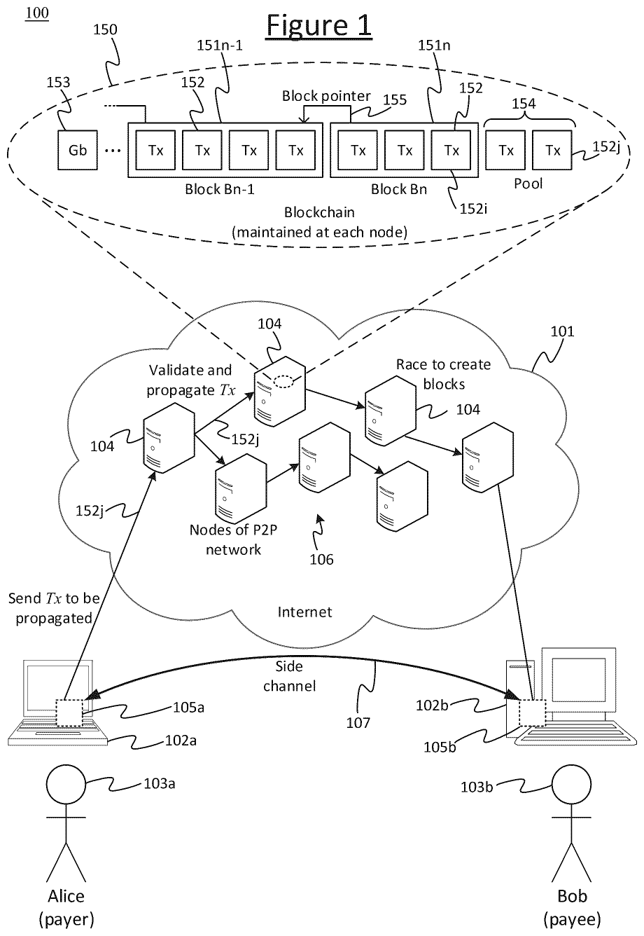

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

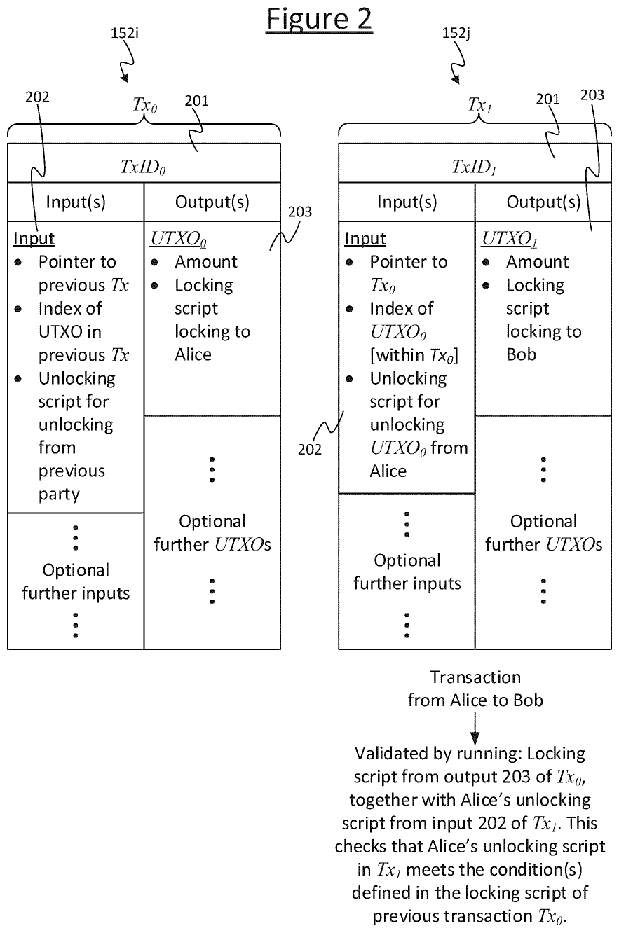

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx/further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

$$< Sig {P}_{A} > < {P}_{A} > \vert \vert [ {ChecksigP}_{A} ]$$

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150.

There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Client Software

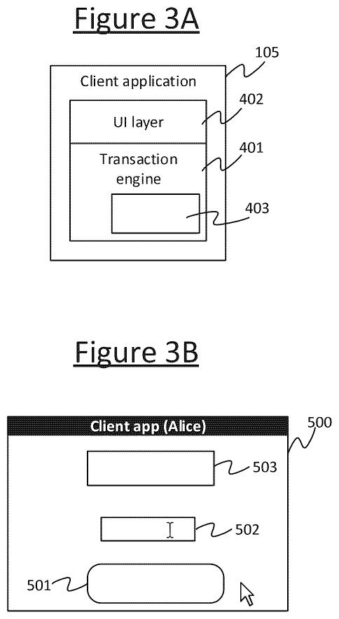

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may comprise one or more data entry fields 502. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### 5. Node Software

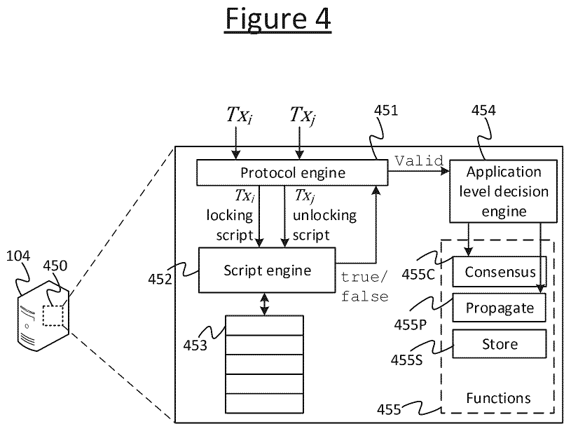

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txⱼ based on the pointer in the input of Txⱼ. Txⱼ may be published on the blockchain 150, in which case the protocol engine may retrieve Txⱼ from a copy of a block 151 of the blockchain 150 stored at the node 104. Alternatively, Txⱼ may yet to have been published on the blockchain 150. In that case, the protocol engine 451 may retrieve Txⱼ from the ordered set 154 of unpublished transactions maintained by the node 104. Either way, the script engine 451 identifies the locking script in the referenced output of Txⱼ and passes this to the script engine 452.

The script engine 452 thus has the locking script of Txⱼ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Tx₁ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Tx₁ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### 6. P2P Network Connections

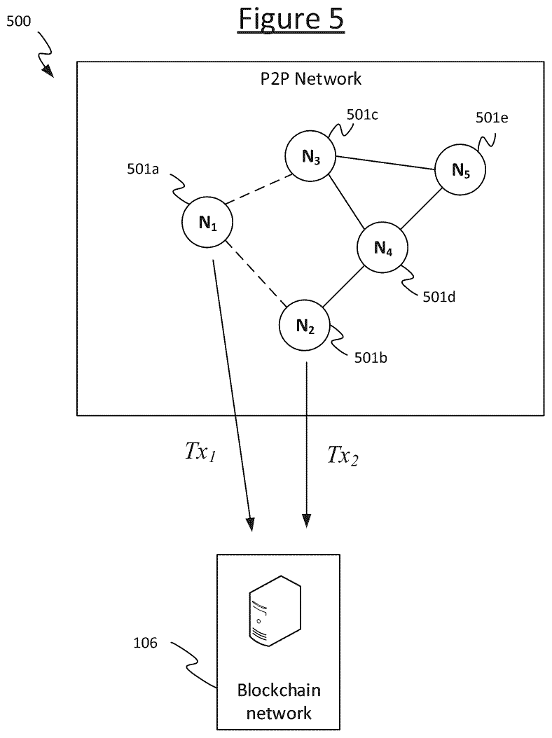

FIG. 5 illustrates an example system that may be used to form connections between P2P nodes. The system comprises a peer-to-peer (P2P) network 500 and a blockchain network 106. The P2P network 500 comprises a plurality of nodes, which are referred to herein as P2P nodes. For instance, the P2P network comprises a first P2P node 501a, a second P2P node 501b, and so on. Whilst only five P2P nodes 501 are shown in FIG. 5, it will be appreciated that in general the P2P network 500 may have any number of P2P nodes 501. Note that as used herein, “first”, “second”, etc., are used merely as arbitrary labels and do not necessarily imply an order, unless the context requires otherwise. The skilled person will be familiar with the concept of a P2P network—i.e. a distributed network where peers are equally privileged, equipotent participants in the network—and so the P2P network 500 per se will not be described in detail, other than to say that the P2P network has a network address. The network address may take any suitable form. For example, the network address may be an IP address or a domain name. The network address may be an address (or identifier) of the P2P network as a whole, or each P2P node may have an address on the network. The P2P network 500 may have one or more purposes or applications. For instance, the P2P network may be a content or file sharing network, or a communication (e.g. video calling) network, a cloud computing network, a remote desktop network, etc.

Each P2P node 501 comprises (or is comprised by) or is implemented in software run on respective computing equipment configured to perform the actions described below as being performed by the P2P nodes 501. In some embodiments, each P2P node 501 may be configured to perform some or all of the actions described as being performed by Alice 103a and/or Bob 103b with reference to FIGS. 1 to 3B. Each P2P node 501 has a respective public key, i.e. has access to the corresponding private key.

As shown in FIG. 5, several of the P2P nodes 501 have existing connections, which are shown by solid lines connecting the P2P nodes 501. For instance, a third P2P node 501c is shown connected to a fourth P2P node 501d and a fifth P2P node 501e. The second P2P node 501b is connected to the fourth P2P node 501d. Further connections are shown. Also shown in the diagram are connections that the first P2P node would like to form, which are shown by broken lines connecting the first P2P node 501a to other P2P nodes. For instance, the first P2P node 501a would like to connect to the second P2P node 501b and the third P2P node 501c, e.g. because these nodes are closest to the first P2P node 501a. Here, “closest” may be in geographical terms or otherwise.

In order to connect with the second P2P node 501b, the first P2P node 501a obtains a public key associated with the second P2P node 501b. The first P2P node 501a may obtain the public key from memory, from publicly accessible resource, e.g. a webpage or the blockchain, from a trusted authority, or from another one of the P2P nodes 501. As another example, the first P2P node 501a may obtain the second P2P node's public key by querying a Domain Name System (DNS) service, e.g. using the P2P network address.

The first P2P node 501a is configured to generate a blockchain transaction (which will be referred to as a first transaction). The first transaction comprises a first output locked to the second node's public key. E.g. the output may be a P2PKH output. The first output is used to alert the second P2P node 501b to the fact that a P2P is attempting to form a connection. For instance, the second P2P node 501b may operate a wallet application that monitors the blockchain for outputs that are locked to the second P2P node's public key. The skilled person will be familiar with other ways of identifying “payments” sent to a public key. The first transaction also comprises the P2P network address, which is used to identify the P2P network which the first P2P node 501a would like to connect to the second P2P node 501b on. The network address may be included as part of the first output of the first transaction, or a second output. The second output may be an unspendable output and/or an OP_RETURN output. The first transaction is signed with a signature that can be verified using the first P2P node's public key. This enables the second P2P node 501b to determine which P2P node 501 is attempting to form a connection.

The first P2P node 501a submits the first transaction to the blockchain network 106, or alternatively to an intermediary who then submits the first transaction to the blockchain network 106.

The second P2P node 501b is configured to determine that the first blockchain transaction has been submitted to (or recorded on) the blockchain 150. As mentioned above, this may be performed by a wallet application operated by the second P2P node 501b. Or, the second P2P node 501 may manually scan the blockchain 150 for transactions having outputs locked to the second P2P node's public key. As another example, a service provider may monitor the blockchain 150 on behalf of the second P2P node 501b and inform the second P2P node 501b when the first transaction is identified. In response to detecting or otherwise identifying the presence of the first transaction, the second P2P node 501b is configured to connect with the first P2P node 501a. Connecting with the first P2P node 501a may involve the second P2P node 501b adding the first P2P node 501a to a list of nodes that the second P2P node 501b will communicate with on the P2P network 500. Here, communicating with the first P2P node 501a is taken to mean accepting incoming data from and sending outgoing data to the first P2P node 501b. Additionally or alternatively, connecting with the first P2P node 501 may involve actively communicating with the first P2P node 501a, i.e. sending data to the first P2P node 501a.

The first transaction is not only beneficial for the first and second P2P nodes 501a, 501b but also for the P2P network 500 as a whole. The first transaction allows other nodes 501 to determine that the first and second P2P nodes 501a, 501b are connected. In other words, upon seeing the first transaction recorded on the blockchain 150, other nodes of the P2P network 500 know that they can communicate with the first or second P2P node via the second or first P2P node, respectively. This improves the connectivity of the P2P network 500 as nodes 501 become aware of more connections and more routes to other nodes 501.

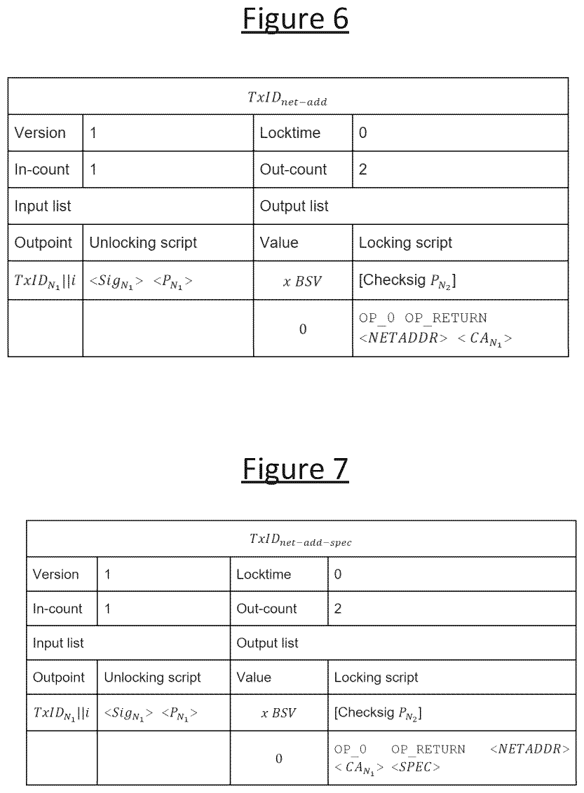

FIG. 6 illustrates an example of a first transaction used to signal a connection between the first P2P node 501a and the second P2P node 501b. The signature and public key of the first P2P node 501a are shown in the unlocking script of the transaction. In this example, the first output is locked to the public key of the second P2P node 501b and a second, different output comprises the network address of the P2P network 500. As shown in this example, the first transaction may comprise an identifier of the first P2P node 501a. The identifier uniquely identifies the first P2P node 501a on the P2P network, and may be certified by a certificate authority (or another form of authority trusted by the P2P network 500). The identifier may be mapped to the first P2P node's public key, allowing the second P2P node 501b to be sure that it is indeed the first P2P node 501a that has generated the first transaction. The mapping may be known in advance, or stored at a publicly accessible resource, e.g. a webpage or blockchain. The identifier is used to establish trust in the first P2P node's identity. It may be a certificate that includes the first P2P node's public key (and possibly information about its owner). Preferably, the certificate does not include the first P2P node's IP address as this may expose the first P2P node's computer to attacks, since the IP address will be public on the blockchain.

As mentioned above, the second P2P node's public key may be obtained from the DNS service. In response to querying the DNS service, the first P2P node 501a may receive the public key and an internet protocol (IP) address of the second P2P node 501b. The first P2P node 501a may choose to connect to the second P2P node 501b based on the IP address. Note that the second P2P node's IP address may be obtained in alternative ways, e.g. it may be provided by a different node 501 that already has an established connection with the first and second P2P nodes 501a, 501b.

Prior to generating the first transaction, the first P2P node 501a may use the IP address of the second P2P node 501b to perform an internet handshake (e.g. a TCP three-way handshake) with the first P2P node 501b. This enables the first P2P node 501a to establish trust in the second P2P node's identity. The second P2P node 501b may send its IP address, signed with a signature corresponding to the second P2P node's public key, to the first P2P node 501a. The first P2P node 501a may then verify the signature using the second P2P node's public key. In these examples, if, and only if, the signature is verified, will the first P2P node 501a submit the first transaction to the blockchain network 106.

The first P2P node 501a may use the first transaction to signal to the second P2P node 501b its specialisms, e.g. capabilities, functions, attributes, etc. That is, the first P2P node 501a may be able to perform certain actions on the P2P network 500 that not all nodes can, or the first P2P node 501b may be able to perform some actions better than others, or better than other nodes can. Examples of specialisms include capabilities such as grid computing, mining, being a DNS node, being a trusted authority node, file sharing, etc. In some examples, a specialism may be an attribute such as good bandwidth, connectivity, internet connection, storage, etc. Here, “good” may be taken to mean better than the average of the P2P network nodes 501. There may be one or more subsets of the P2P nodes 501, each subset having at least one specialism in common. The first transaction may include one or more flags, each of which indicate a respective specialism. This improves the efficiency of the P2P network 500 as the second P2P node 501b knows whether or not to send certain types of data or requests to the first P2P node 501a based on the first P2P node's specialisms.

FIG. 7 illustrates an example of a first transaction that includes a specialism flag. The specialism flag(s) may be included in the first output or the second output.

Optionally, the first transaction may include, in addition to the first output that is locked to the second P2P node's public key, another spendable output that includes at least two alternative locking conditions. This output is referred to as the third output, but it need not appear third in the list of outputs. As a first locking condition, the third output may be locked to a public key of the first P2P node 501a. As a second locking condition, the third output may be locked to a public key of the second P2P node 501b. The public keys may be the same as or different to the public keys discussed above. In other words, the first and/or second P2P nodes 501a, 501b may have more than one public key. In these examples, the third output being unspent is interpreted by the second P2P node 501b as the connection between the first and second P2P nodes 501a, 501b being available (i.e. not terminated). When the third output is spent, the connection is interpreted as the connection being terminated, e.g. because the first node 501a has gone offline. Upon seeing that the third output has been spent, the second P2P node 501b may disconnect from the first P2P node 501a.

The first P2P node 501a may generate a second transaction that spends the third output, e.g. in the case that the first P2P node 501a can no longer maintain a connection with the second P2P node 501b. The second transaction includes an input that references the third output of the first transaction and includes a signature corresponding to the first P2P node's public key to which the third output is locked. FIG. 9 illustrates an example of a second transaction.

Alternatively, the second P2P node 501b may generate a second transaction that spends the third output, e.g. in the case that the second P2P node 501b can no longer maintain the connection with the first P2P node 501a, or the first P2P node 501a has acted maliciously or against the policy of the P2P network, or has been hacked, etc. The first P2P node 501a is offline at least from the perspective of the second P2P node 501b, but in some examples may maintain an active connection with other nodes, e.g. the third P2P node 501c. Spending of the third output of the second transaction signals to other nodes of the network that it is not recommended to communicate with the first P2P node 501a via the second P2P node 501b since the first P2P node 501a has not followed the network protocol correctly, or that it is not recommended to communicate with the first P2P node 501a at all. The second transaction includes an input that references the third output of the first transaction and includes a signature corresponding to the first P2P node's public key to which the third output is locked.

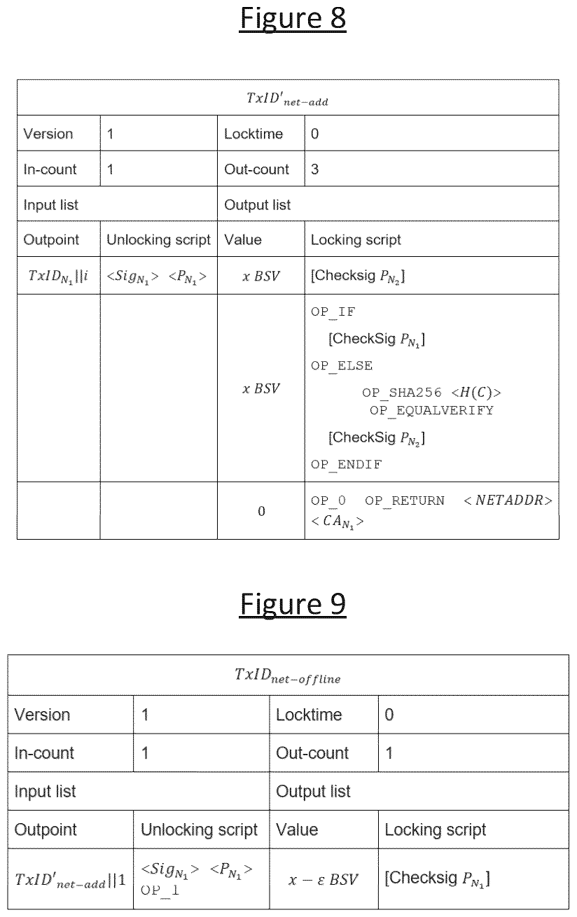

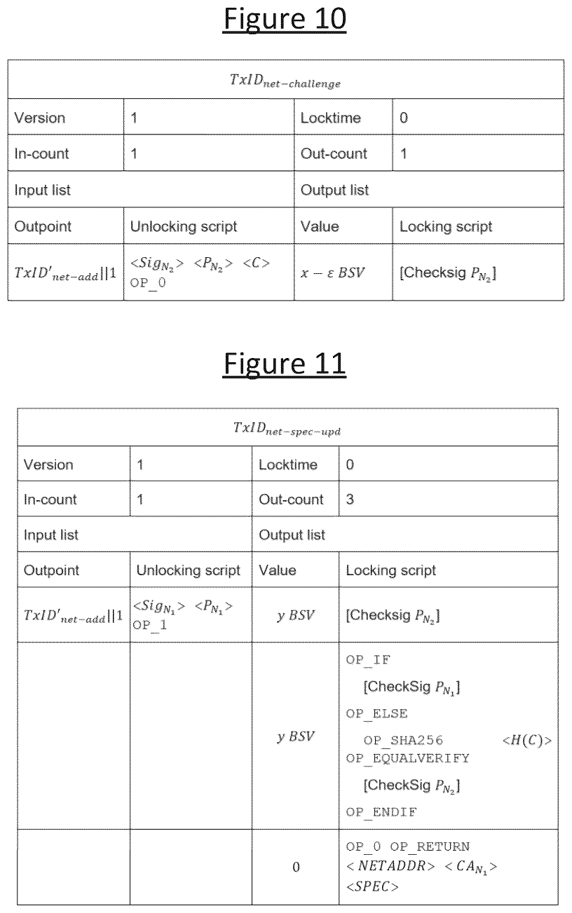

In some examples, as shown in FIG. 8, the second locking condition of the third output (which appears second in the list of outputs in FIG. 8) may include a hash value and in order for the third output to be unlocked, the input that spends the third output must include the preimage of the hash value. The preimage may be a challenge which the second P2P node 501b must obtain in order to unlock the third output. For example, the challenge may be obtained from a trusted authority. An example of a second transaction generated by the second P2P node 501b that includes the challenge data is shown in FIG. 10.

FIG. 11 illustrates an example of a transaction that can be used to update the first P2P node's specialisms, or rather inform the second P2P node of the updated specialisms.

Whilst the above description has focused on the interaction between the first and second P2P nodes 501a, 501b, the first P2P node 501a may perform equivalent actions for one or more additional P2P nodes 501. For example, in FIG. 5 the first P2P node 501a connects with a third P2P node 501c by obtaining the third P2P node's public key, and generating a transaction that comprises an output locked to that public key. The transaction also includes the P2P network address.

The first P2P node 501a is also configured to determine (i.e. identify) connections between other P2P nodes, e.g. the fourth and fifth P2P nodes 501d, 501e based on transactions recorded on the blockchain 150, e.g. a transaction having an input signed by the fourth P2P node 501d and an output locked to the public key of the fifth P2P node 501e. The first P2P node 501a may use the identified connections to route data, etc. to a particular P2P node 501. For instance, taking the example of FIG. 5, having connected to the second P2P node 501b, data may be routed to the fifth P2P node 501e via the second and fourth P2P nodes 501b, 501d.

In some examples, the P2P nodes may use a first type of private key (e.g. RSA) to sign messages on the P2P network 500 that cannot be used to sign transactions on the blockchain network 106, which requires a second type of private key (e.g. ECDSA). The P2P nodes 501 may convert from a respective private key of the first type to a respective private key of the second type by hashing (with one or more hash functions, which may or may not be the same, e.g. double SHA256) the respective private key of the first type.

### 7. P2P Overlay Model

A specific example of the described embodiments will now be provided. This section discloses an incentive mechanism for P2P network topology attestation. To add incentive for the P2P network, nodes may attest data on the blockchain through associated transaction payments on the blockchain network. These payments are received by nodes involved in the communication process. Throughout this section we will detail how the nodes can attest to joining, update their specifications on the P2P network and keep a proof of their adjacent nodes on the blockchain.

This solution adds economic incentives for all types of data transfers between the nodes. Furthermore, it is flexible, in the sense that P2P network nodes can keep their original P2P protocol communications to which they add another communication layer that transfers the rewards. We will label the nodes of the P2P network by Nᵢ where i is a positive integer or an index set—depending on the context.

### 7.1 Network Setup

In this section we show how a node N₁ can safely join a P2P network, offering enough incentives to be accepted. Moreover, each time the node N₁ wants to connect to any other node from the P2P network, it should follow the same procedure we describe below. This ensures the blockchain will store the full network topology of the P2P network.

The joining process is as follows: assume a new node N₁ wants to join the network with address NETADDR. To find available peers N₁ can connect to on the network, it can query the DNS service by sending a GET-like request to a link of the form:
protocol://mesh.networks/chosen_network

The retrieved data is JSON formatted, containing a list of nodes' internet address and elliptic curve public key (for example encoded in Bitcoin format). An entry example is:

```
{
  address: “192.168.0.1”
  pkey:
“0x02f54ba86dc1ccb5bed0224d23f01ed87e4a443c47fc690d7797a13d41d2340e1a”
}
```

Based on the received list of available peers, N₁ picks a peer N₂ to connect to using the internet address as seen in the entry example above. At this moment, the two nodes N₁ and N₂ follow the protocol described below:
1. N₁ obtains the internet address of N₂ from the JSON entry.
2. N₁ starts an internet handshake with N₂. Such a handshake is network-dependent. For example the two nodes can opt for a TCP three-way handshake as described in RFC 793.
3. N₂ sends its internet address signed with the JSON entry public key.
4. N₁ validates the identity of N₂ by using the public key from the JSON entry and checking the signature against the internet address of N₂.
5. N₁ creates a transaction on the blockchain, with two outputs as seen in FIG. 6. The first output, a P2PKH locking script redeemable by N₂. The second output, a locking script including the unique identifier CA_{N}_{₁}, together with the network address NETADDR it is joining. The CA_{N}_{₁} identifier is issued by a Certificate Authority and its purpose is to identify in a trusted manner the identity of the network node N₁.
6. Once N₂ sees the transaction TxID_{net-add} confirmed on the blockchain, it adds N₁ to its list of adjacent peers

Steps 3 and 4 prevent other nodes from cheating by executing a spoofing attack and using the internet address of N₂. N₁ is communicating with the node that uses the internet address of N₂ by step 2. It can be sure the node is N₂, because N₂ is the only node that can sign its internet address with the public key available in the JSON entry. Thus, steps 3 and 4 enable a public key infrastructure.

One issue to address is whether N₂ is a dishonest node and does not add N₁ to its list of adjacent nodes. We show how N₁ can safely join the network and be sure it isn't being defrauded by N₂. Each node has an assigned identity certificate CA which reflects their identity issued by a trusted authority. Node N₁ can contact the authority that issued the certificate, proving it has been defrauded. At this moment the trusted authority can issue a flag, which will make the other P2P nodes collaborating with the node N₂ aware that this is not a trusted node.

### 7.2 Network Fairness Architecture

In addition to offering node N₁ the possibility to cross-check with the trusted authority and report node N₂ in case it is being defrauded, we can implement a consensus that can further protect the P2P network from bad actors. This consensus is reliant on the majority of nodes acting honestly and being constantly incentivised.

Let's assume node N₂ is connected to nodes N_{2,1}, . . . , N_{2,n}. It is in the interest of each of adjacent nodes of N₂ to keep it honest. We detail two such scenarios in which it is in the interest of nodes N_{2,1}, . . . , N_{2,n}. to keep N₂ honest:
If N₂ is dishonest and not adding new nodes N₁ to its connections, then the nodes propagating requests to N₂ might be losing rewards from sending requests to a dishonest node.
If N₂ is not updating the network correctly when node N₁ goes offline, then nodes N_{2,1}, . . . , N_{2,n} can see on the blockchain that N₂ is propagating requests to node N₁. This means they are paying N₂ for an extra node.

In each of the two above scenarios, the adjacent nodes can either penalise N₂ by offering lower rewards in the next request propagation, or they can take N₂ completely offline from the network.

We remark that this consensus is offloading the process of N₁ checking whether N₂ is honest and moreover, it provides an incentive for the existing nodes in the network to ensure that their adjacent nodes are behaving honestly. We also highlight that if the burden would have been on node N₁ to do further checks on the nodes connected to N₂, node N₂ could have created fake identities and hence trick node N₁, enabling a Sybil attack.

### 7.3 Identity Linkage

In the case of P2P networks that use RSA keys, one way to establish their identity is to link their RSA private key k_{RSA} to the ECDSA private key k_{ECDSA} that will be used on the Bitcoin network to sign transactions. This can be done through the following equation:

k_{ECDSA}=H₁(H₀(k_{RSA}))

where H₁ and H₀ are two hash functions, not necessarily different. Then the ECDSA public key is defined as:

$${P}_{E C D S A} = {k}_{E C D S A} \cdot G$$

If node N₁ holds several RSA private keys that are used within the network, then the index of the keys can be included in the generation of the ECDSA private key as such:

$${k}_{E C D S A} = {H}_{1} ( {H}_{0} ( {k}_{R S A} \vert \vert index ) )$$

To prove the link between their RSA key and ECDSA key, the P2P node can sign their ECDSA public key with their RSA private key using the RSA digital signature cryptosystem.

### 7.4 Node Specialisation

One area of optimisation for the network is adding node specialisation, where each node may specialise to perform a specific function. There are several such specialisations we can think about such as: grid computing, mining, being a DNS node, being a trusted authority node, file sharing etc. Certainly a node can join a P2P network and accept any kind of request, which would be classified as a general purpose node. If specialisation exists, it can lead to a network structure which modularises the P2P network as shown further below.

FIG. 7 shows how such specialisations can be done in the network setup phase with a simple modification of the transaction TxlD_{net-add} in step 5 of the network setup.

The specialisation flag may be expressed in a standard format, e.g.:

```
SPEC := {
    “role”: [“data”,
      “dns”]
  }
```

A node using the SPEC entry above tells the network that its specialisation is that of a data sharing node and can be part of the DNS service-providing nodes. Such a standardisation may be issued, for example, by the existing DNS service which helped the node N₁ initially find the desired network.

### 7.5 Network Update

In the previous section we described a procedure through which a node N₁ can join the network and offer incentives, ensuring a degree of fairness. We now show how to preserve network integrity, where the blockchain transactions should reflect changes of the network structure such as nodes going offline or changing their specialisation, whilst guaranteeing economic incentives.

This section builds an update procedure through which nodes can update the network structure in order to preserve its integrity. One way to achieve this process is to modify the network setup protocol described in the previous section such that the second transaction output of TxID_{net-add} is spendable. If the output is being spent, then we interpret this as a node disconnecting from the P2P network. For brevity, we will say in this case that the node goes offline.

Thus, the focus lies on understanding how the second output of TxID_{net-add} can be spent. This is important since we do not want to provide the wrong incentives to the network and risk its integrity.

In order to do so, we need the data that produced the certification CA_{N}_{₁}. We will call this data a challenge C (e.g. a random integer). C is known only to node N₁ and the issuing trusted authority. In the figures below we fix the hash function H to correspond to the function computed by the opcode OP_SHA256.

We modify TxID_{net-add} given in FIG. 6, and used in step 5 of the network setup procedure detailed above. Nodes may adopt the transaction format shown in FIG. 8 in the setup protocol to enable the functionalities presented in this section.

The locking script given in the second output enables N₁ to signal to the P2P network that it is going offline. To do so, N₁ performs the following steps:
1. N₁ creates a transaction as given in FIG. 9, providing its signature and spending the second output of TxID′_{net-add} given in FIG. 8.
2. N₁ can safely disconnect from the P2P network.

If N₁ is dishonest and doesn't perform the protocol above to go offline, then N₂ follows the protocol below:
1. N₂ acquires the challenge C from the trusted authority.
2. N₂ broadcasts the transaction in FIG. 10, providing its signature and spending the second output of TxID′_{net-add} given in FIG. 8.

The scenarios that can occur when updating the network are as follows, emphasizing the incentives and security of this scheme:
N₁ is an honest node and when going offline spends the second output of the transaction through its signature, recovering the money. This is the primary scenario, since N₁ also has the economic incentive to recover its money.
N₁ is a dishonest node and does not spend the second output of TxID′_{net-add} to signal to the network that it is going offline. In this case, node N₂ can contact the trusted party proving that N₁ did not follow the update consensus. Once the Certificate Authority that issued CA_{N}_{₁} is online, N₂ can obtain the challenge C with which it unlocks the second output of TxID′_{net-add} and consequently signalling to the network that N₁ went offline.

If N₁ repeats the behaviour of not updating the network when going offline, then N₂ can flag N₁ as being untrustworthy and refusing further joining requests from node N₁. Moreover, we could also have the Certificate Authority flag node N₁ as untrustworthy and invalidating the issued identity. For example, flagging can be done through a transaction. Finally, we show how N₁ can change its specialisation SPEC. To do so, N₁ need only create a new transaction as given in FIG. 11, spending the second output of TxID′_{net-add}.

In conclusion, the update procedure we proposed ensures network integrity by keeping its structure up-to-date and offering the required economic incentives.

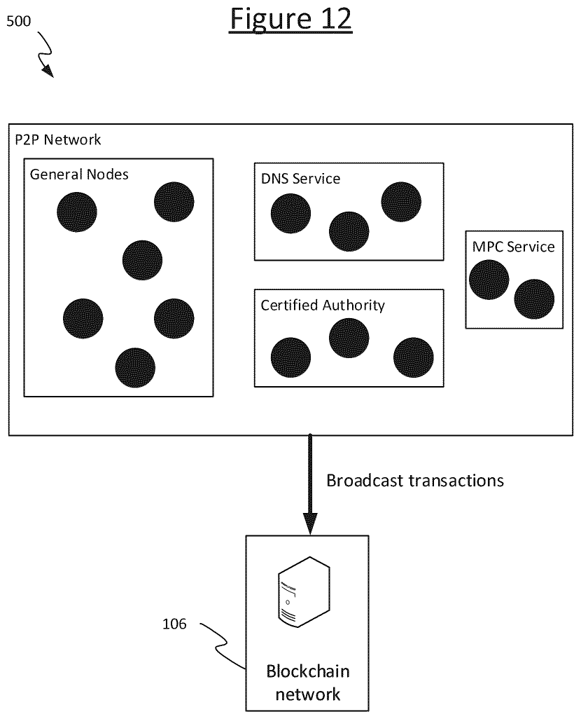

An example P2P overlay model according to the described embodiments is shown in FIG. 12. The P2P network can implement several services through node specialisation, as described above. This leads to network modularisation, whereby nodes assume certain roles in order to make the P2P network communication more efficient.

In order to implement the following services each node N₁ joining the P2P network needs to define their SPEC flag. FIG. 12 offers a visual representation of the P2P modularisation, with the nodes offering the following services:
DNS service: SPEC:={“role”: “dns” }
Certificate Authority service: SPEC:={“role”: “CA” }
Multiparty computation (MPC) service: SPEC:={“role”: “MPC” }

Since the P2P network holds the attestation of its structure on the blockchain, the DNS service can offer a service that can make the network searchable (also called a crawler service). By monitoring the network structure, the crawler can hold a graph of the current network which can facilitate search applications.

### 8. Coordinating Data Transfer

### 8.1 Graph Theory

Since the connections between each node on any P2P network form a graph, we recall some fundamental ideas in graph theory. A graph is a collection of objects (nodes) in which some pairs of objects are related (represented as edges). An example graph is shown in FIG. 13, where the nodes of the graph are labelled by Nᵢ, where i is a positive integer or an index set depending on the context. A directed graph is a special kind of graph where edges between nodes have a direction—also called directed edges.

Throughout the following we will manage graph information flow from node N₁ to Nₖ. If N₁ is the information request node, then we call N₁ the source node or the requesting node. Moreover, we call Nₖ the sink node or the target node, when Nₖ is the end node of the information flow.

Note that in a real-world implementation, P2P networks are not fixed, and nodes can arbitrarily connect and disconnect with peers.

### 8.2 Gnutella

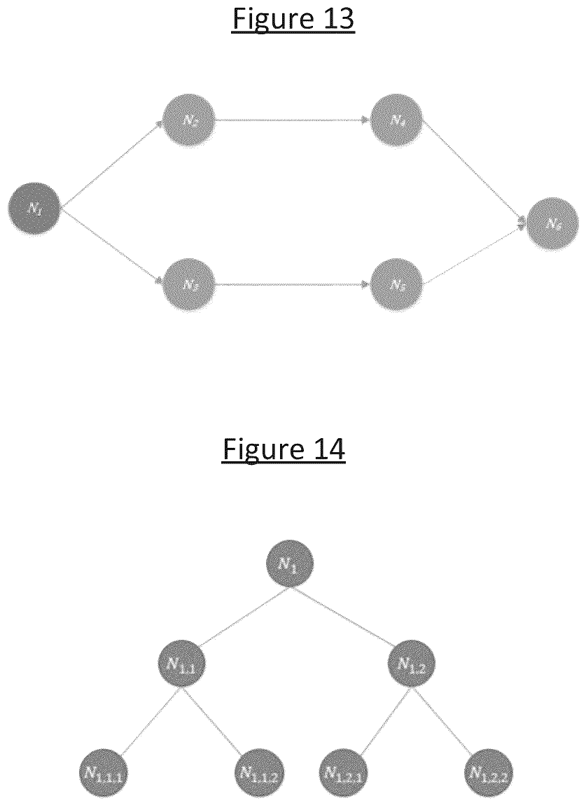

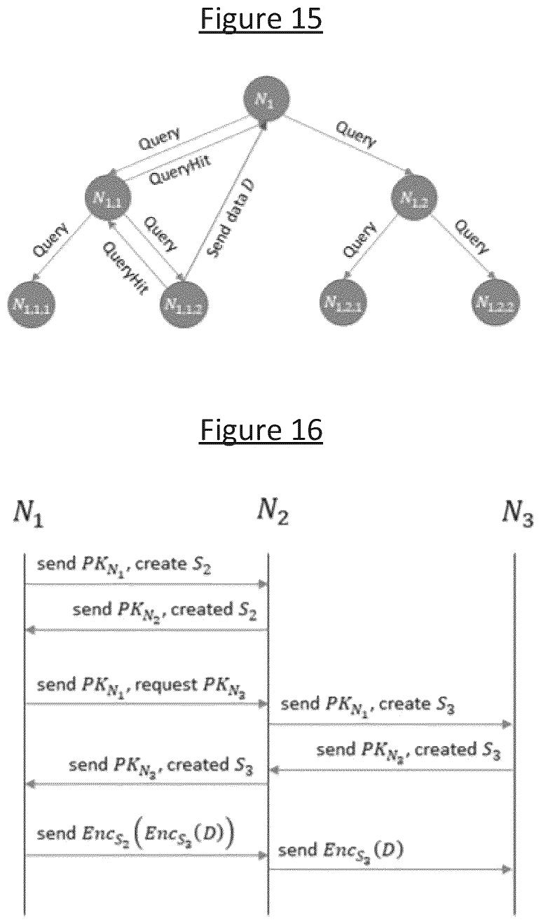

By way of an example application context, Gnutella is one example of a decentralised P2P network file sharing service. To show how the protocol works, we assume a network structure as in FIG. 14. Node N₁ requests data D through the network and the Gnutella protocol allows N₁ to find the node N_{1,1,2} holding the data. Once the request reaches N_{1,1,2}, it directly transfers the data to N₁ outside the P2P network structure—also called an off-network transfer. FIG. 15 shows a visualisation of this protocol.

The steps of the data transfer protocol are as follows:
1. Node N₁ requests a file by sending a query message Query for data D to its adjacent peers N_{1,1} and N_{1,2}.
2. Each node N_{1,i} forwards the message Query to its adjacent peers N_{1,i,j}.
3. N_{1,1,2} receives the message Query and sends a reply message QueryHit containing its identity to N_{1,1}.
4. N_{1,1} forwards the message QueryHit to N₁
5. N₁ contacts N_{1,1,2} and receives data D from it.

### 8.3 Onion Routing

By way of an example implementation, the onion routing protocol is an example routing protocol which ensures communication privacy between nodes on a network, and it is used as part of the Tor network for example. To exemplify the routing protocol, we assume node N₁ is connected to N₂, which in turns is connected to node N₃. This protocol enables node N₁ to send data D to N₃ as in FIG. 16, where we denote the public key of node Nᵢ by PK_{N}_{ᵢ}.

The steps of the protocol are as follows:
1. N₁ sends its public key PK_{N}_{₁} to N₂, and a request for the creation of a shared key S₂ through a Diffie-Hellman key exchange.
2. N₂ replies with its public key PK_{N}_{₂}, telling N₁ that it created the shared key S₂. N₁ also privately computes the key S₂.
3. N₁ requests the public key of N₃ from N₂. N₁ attaches its public key to the request. N₁ does not know the IP address of N₃.
4. N₂ forwards the request to N₃, requesting the creation of a shared key S₃.
5. N₃ sends its public key to N₂ and confirms the creation of the key S₃. S₃ is shared between N₁ and N₃.
6. N₂ further relays the public key to N₁ together with the confirmation of the creation of key S₃. N₁ privately computes the key S₃.
7. N₁ encrypts data D first with the key S₃ and then with S₂: Enc_{S}_{₂} (Enc_{S}_{₃}(D)). N₁ sends the encrypted data to N₂.
8. N₂ decrypts the encrypted data using S₂ and obtains Enc_{S}_{₃}(D). N₂ sends the encrypted data Enc_{S}_{₃}(D) to N₃.
9. N₃ decrypts Enc_{S}_{₃}(D) and receives data D.

### 8.4 Data Transfer

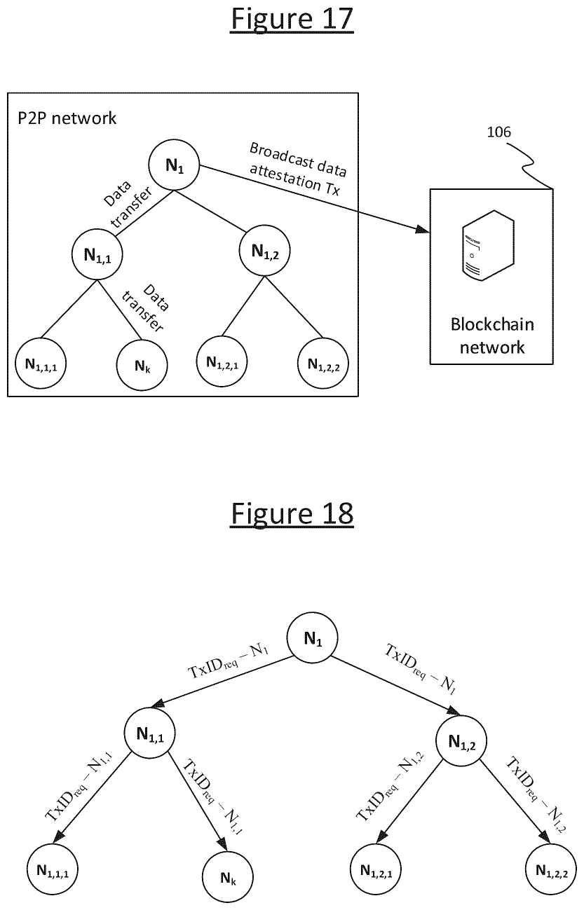

Embodiments of the present invention enable the blockchain network to act as a coordinator for the transfer of data between P2P nodes of a P2P network. An example system for implementing the described embodiments is shown in FIG. 17. The system comprises a P2P network comprises a plurality of P2P nodes and a blockchain network 106. The system comprise the P2P nodes 501 of the P2P network illustrated in FIG. 5. In some embodiments, the P2P nodes may undergo the process of forming connections as described with reference to FIGS. 5 to 12.

The P2P network comprises a target node with access to target data and a requesting node that requests the target data. The target data may comprise media data such as, for example, one or more images, one or more videos, one or more audio files, etc. The target data may comprise one or more documents. In general, the target data may take any form. The P2P network also comprises a plurality of intermediate nodes. The requesting node and the target node are connected via the intermediate nodes. That is, the requesting node is connected to one or more intermediate nodes, one or more of those intermediate nodes are connected to one or more further intermediate nodes, and so on, until an intermediate node is connected to the target node. For example, as shown in FIG. 17, the requesting node N₁ is connected to nodes N_{1,1} and N_{1,2}, and node N_{1,1} is connected to the target node Nₖ. It will be appreciated that FIG. 17 is just an example, and in practice there may be many more intermediate nodes connecting the requesting node to the target node. Each node of the P2P network is associated with a respective public key.

The requesting node obtains a hash value that is based on a request for the target data. More specifically, the request for the target data (the “target request”) is hashed with a first hash function to obtain a first hash value, and the result is hashed with a second hash function to obtain a second hash value. The first and second hash functions may be the same, or they may be different. The first and/or second has functions may be cryptographic functions (e.g. from the SHA family of hash functions, such as SHA256). Alternatively, non-cryptographic hash functions may be used. In some examples, the requesting node generates the first and second hash values. In other examples, the requesting node may receive the first and/or second hash values from a different node, or from a trusted third party such as a centralised service that maps requests to data.

The target request may be based on the target data or an identifier thereof, e.g. the target request may be a hash of the target data. The target request may be mapped to the target data (e.g. by an optional centralised service) such that the target node may determine which data is being requested. For example, the target node may store a database of data requests mapped to the target data. The target node may inform a centralised service, of the mappings. For instance, the target node may inform the centralised service that is has media file A mapped to request number 123. In some examples, such a centralised service may be provided by a collection of the network nodes. The requesting node may contact the centralised service and inform the service that it would like to obtain media file A. In response, the centralised service may provide the requesting node with request number 123. The manner in which the requesting node obtains the target request is not essential for implementing the described embodiments.

In some examples, the first hash value may be obtained by hashing the target request and additional data, such as a timestamp, or a secret value known to the requesting node and the target node. For example, as an option a centralised service may send the secret value to the requesting node and/or the target node.

Note that any reference to the centralised service is optional and it is envisaged that in at least some embodiments such a centralised service does not exist.

### 8.4.1 Flooding Requests

Some embodiments described herein involve the flooding of the P2P network with requests for the target data.

The requesting node generates a primary request transaction, which is a blockchain transaction. The primary request transactions includes the second hash value and one or more outputs. Each output is locked to a respective public key of a respective one of the intermediate nodes to which the requesting node is connected to on the P2P network. For example, if the requesting node is connected to two nodes (as shown in FIG. 17), the primary request transaction includes an output locked to a first one of the two nodes and a separate output locked to the second one of the two nodes. The second hash value may be included in the outputs that are locked to the respective public keys of the respective nodes. For instance, each output may include a locking script configured to implement a hash puzzle, wherein the hash puzzle comprises the second hash value. The hash puzzle may require an unlocking script of a spending transaction (i.e. a transaction attempting to unlock the locking script containing the hash puzzle) to include the first hash value or the target request. Additionally or alternatively, in some examples, the second hash value may be included in an OP_RETURN output. The primary request transaction may also comprise a network identifier of the requesting node (e.g. an IP address of the requesting node) and/or a certified identifier of the requesting node (e.g. an identifier certified by a certificate authority attesting to the identity of the requesting node). The requesting node submits the primary request transaction to the blockchain network 106. The requesting node may also send the primary request transaction directly to the relevant intermediate nodes, i.e. the nodes whose public keys to which the outputs of the transaction are locked. This is beneficial for the intermediate nodes as it is expensive for nodes to listen to the blockchain to find new request transactions. FIG. 20 illustrates an example of a primary request transaction with two outputs locked to respective public keys of the intermediate nodes connected to the requesting node. In this example, the transaction also includes the network address and identifier of the requesting node.

As shown in FIG. 20, the primary request transaction may include a locktime. The locktime specifies an earliest time from which the primary request transaction can be included in a block, i.e. recorded on the blockchain. The locktime may be specified using a UNIX time or a block height. The locktime incentivises the intermediate nodes to respond to the request within a specified time.

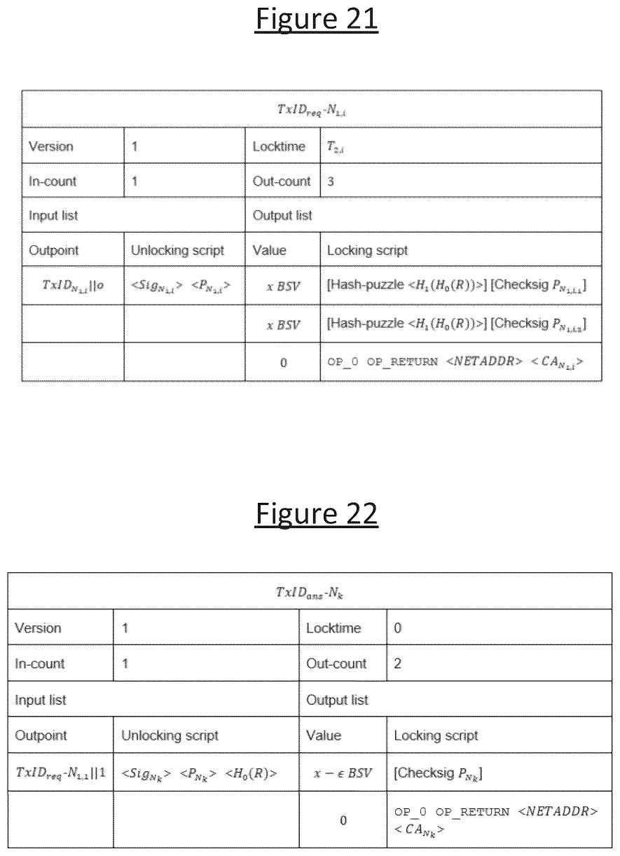

Each of the intermediate nodes that receive the primary request then generates a respective secondary request transaction. Here, “receiving” a transaction means determining that a transaction comprises an output locked to the respective public key of the respective node. Each secondary request transaction generated by a respective intermediate node is similar to the primary request transaction in that it includes the second hash value and one or more outputs, where each output is locked to a respective public key of a respective node to which the respective intermediate node is connected. For example, a first one of the intermediate nodes may be connected to three other intermediate nodes, and therefore the secondary request transaction generated by that node would contain three outputs locked to respective public keys (one key per output) of the three other intermediate nodes. Like the primary request transaction, the second hash value may be included in a hash puzzle. The secondary request transactions are submitted to the blockchain network 106. FIG. 21 illustrates an example of a secondary request transaction.

Like the primary request transaction, each secondary request transactions may also include a locktime specifying an earliest time from which the respective secondary request transaction can be included in a block, i.e. recorded on the blockchain.

In some examples, one of the secondary request transactions submitted by the first set of intermediate nodes (i.e. those nodes immediately connected to the requesting node) will be locked to the target node's public key. In other examples, the first set of intermediate nodes will each generate a respective request transaction comprising one or more outputs locked to respective public keys of a second set of intermediate nodes. The process continues until the target node receives a secondary request transaction. In this way, a path of nodes is formed from the requesting node to the target node via one or more intermediate nodes. With the exception of the target node, each node in the path is connected to the next node via the sending of a request transaction (primary in the case of the requesting node and secondary in the case of the intermediate nodes) to that next node's public key. For example, in FIG. 17 a path is formed from the requesting node N₁ to the target node Nₖ via one intermediate node N_{1,1}. FIG. 18 illustrates the sending of the primary and secondary transactions from the requesting node and intermediate nodes, respectively.

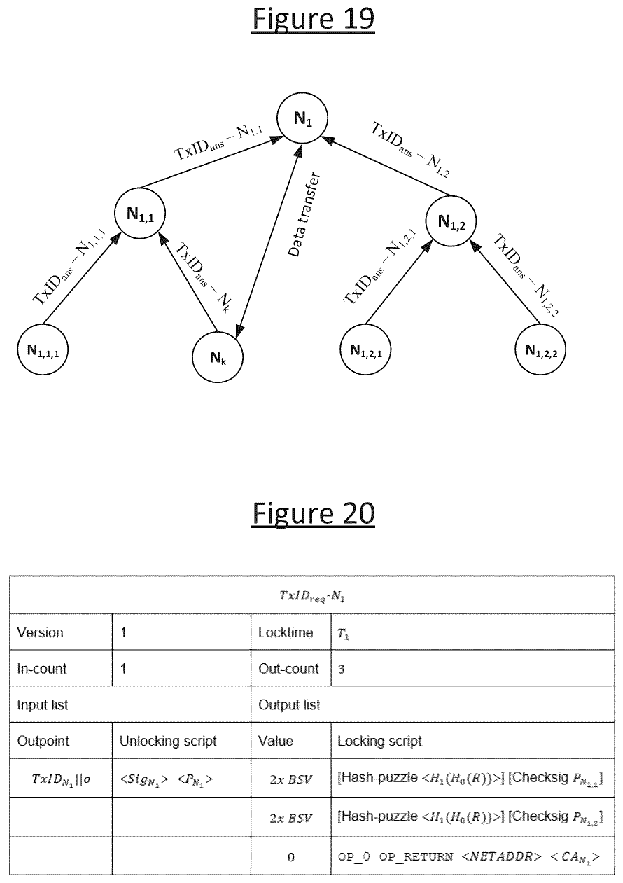

The target node is thus alerted to the request for the target data, and the target data is transferred to the requesting node. There are several options for transferring the target data to the requesting node, which are discussed below. In response to receiving the secondary transaction, the target node may submit a response (or answer) transaction to the blockchain that spends the output of the secondary transaction that is locked to the target node's public key in order to signal that the target node has the requested data and that the request has been received. In the examples where the secondary transaction includes a hash puzzle based on the second hash value, an input of the response transaction includes the first hash value. This then enables the intermediate nodes to submit respective response transactions that spend the respective outputs of the respective request transactions that are locked to their respective public keys. Note that “spending an output” is taken to mean “assigning the digital currency locked by the output to an output of the transaction than unlocks that output”. FIG. 19 illustrates the spending of the request transactions using the response (or answer) transactions, and FIG. 22 illustrates an example of the response transaction submitted by the target node.

In some examples, the target node may determine that it has the target data by identifying the second hash value included in the request transaction. That is, the target node may recognise that the second hash value is associated with the target data item (or the target request), e.g. the second hash value may be included in a database mapped to the request. In other examples, the target node may have access to the first hash value (e.g. stored in a database mapped to the target request), identify the second hash value from the request transaction, and verify that the first hash value hashes to the second hash value. If it does, the target node has the corresponding target request. In some examples, the second hash value may be obtained by hashing the first hash value with a timestamp. In these examples, the target node may try hashing the first value with a range of different time stamps to verify that the second hash is based on a known first hash value.

As an option for transferring the target data, the target node may transfer the data directly to the requesting node, as shown in FIG. 19. The target data may be sent off-chain, e.g. over a (secure) communication channel between the target node and the requesting node. In these examples, the transferring of the target data may be attested to on the blockchain. For instance, a hash of the target data may be recorded on the blockchain as part of an attestation transaction. The attestation transaction may be generated by the requesting node and/or the target node. Alternatively, the target data may be sent on-chain, i.e. included in a blockchain transaction submitted to the blockchain network 106 by the target node. In some examples, the transfer of the target data is only possible (or at least conditional on) the requesting node paying an amount of the underlying digital asset to the target node, e.g. via the attestation transaction.

The target node may already have access to the requesting node's public key for sending the data on-chain and/or the requesting node's network address (e.g. IP address) for sending the data off-chain. In some examples, the requesting node may send the public key and/or network address to the target node. For example, in response to receiving a secondary request transaction, the target node may publish a message containing the target node's network identifier (e.g. IP address) and the first hash value. Publishing the message may comprise broadcasting the message to the P2P network. By including the first hash value, the requesting node may determine that the target node has received the request. The requesting node may then use the target node's network identifier to connect with the target node, and the target node may send the target data to the requesting node. In some examples, before connecting to the target node, the requesting node may verify that the first hash value included in the message is correct.

As an alternative option for sending the target data to the requesting node, the target node may transfer the target data to the requesting node via the intermediate nodes that form the path connecting the requesting node to the target node. The target node may obtain the respective public keys of the other nodes in the path, i.e. the requesting node and the one or more intermediate nodes. The target node may already have access to the public keys, e.g. stored in memory, or they may be obtained from the blockchain, e.g. from the request transactions, or from a centralised service. The target node using the obtained public keys to encrypt the target data. That is, the target data is encrypted with each of the public keys, first with the requesting node's public key, then with the public key of the first intermediate node in the path, then with the public key of the second intermediate node in the path, and so on, until the target data has been encrypted with each public key. In some examples, the target data may first be split into one or more data packets, and each data packet may be encrypted with the set of public keys.

The data packet(s) encrypted with the set of public keys will be referred to as “final encrypted messages”. The data packet(s) encrypted with only the requesting node's public key will be referred to as “first encrypted messages”. That is, the data packets are each encrypted with the requesting nodes public key to obtain the first encrypted messages, and the first encrypted messages are each encrypted with the remaining public keys to obtain the final encrypted messages.

The target node sends the final encrypted message(s) to the final intermediate node in the path, i.e. the intermediate node that submitted the secondary request transaction having an output locked to the target node's public key. The final intermediate node decrypts the final encrypted message(s) using the private key corresponding to that node's public key to obtain a set of encrypted messages. That set of encrypted messages are encrypted with the public keys of the other intermediate nodes and the requesting node. The final intermediate node sends the set of encrypted messages to the next intermediate node in the path (in the direction of the requesting node) or, if there is only one intermediate node in the path, to the requesting node. Each intermediate node that receives a set of encrypted messages decrypts the messages with their respective private key and sends the resulting set of encrypted messages to the next node in the path. Eventually, the requesting node receives the one or more first encrypted messages. The requesting node may then decrypt the one or more first encrypted messages with its private key to obtain the one or more data packets. The target data is then obtained by combining the data packets.

In some examples, the encrypted messages are submitted from node to node in one batch. In other examples, the encrypted messages are submitted from node to node one at a time.

The encrypted messages may be sent node to node via an off-chain channel. Alternatively, the encrypted message may be sent via the blockchain. E.g. each node may send one or more data transactions to the blockchain, wherein each data transaction comprises one or more encrypted messages.

Optionally, the requesting node may submit an attestation transaction to the blockchain to attest to the obtaining of the data packets. E.g. the attestation transaction may include a hash of the target data. The requesting node may submit a single attestation transaction to the blockchain, or a respective attestation transaction may be submitted for each data packet, e.g. each transaction may include a hash of a respective data packet. Similarly, each intermediate node may submit one or more respective attestation transaction to the blockchain to attest to receiving the one or more encrypted messages from the previous node in the path. In some examples, the transfer of each encrypted data packet is only possible (or at least conditional on) the node that receives the encrypted data packets paying an amount of the underlying digital asset to the node that sends the encrypted data packets, e.g. via the attestation transaction.

### 8.4.2 Chained Requests

Some embodiments described herein involve sending a request for the target data via a chain of intermediate nodes to the target node.

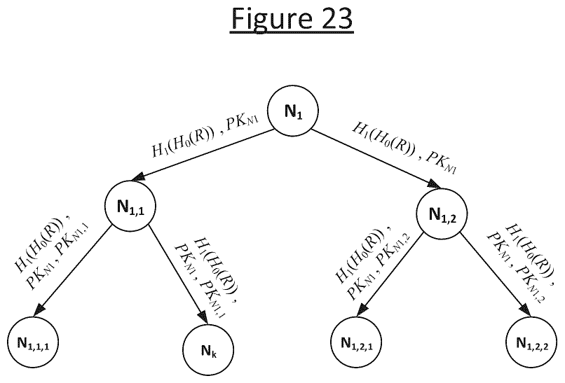

The requesting node sends the second hash value (which is based on the request for the target data) to one or more intermediate nodes that are connected to the requesting node. The requesting node also sends its public key. For instance, as shown in FIG. 23, the requesting node N₁ sends the second hash value H₁(H₀(R)) and its public key PK_{N1} to each node that it is connected to, which in this example is intermediate node N_{1,1} and intermediate node N_{1,2}. Each intermediate node that receives the second hash value forwards the second hash value and the requesting node's public key PK_{N1} to one or more intermediate nodes that are connected to that intermediate node. The public key of the intermediate node is also sent along with the second hash value and the requesting node's public key PK_{N1}. For example, intermediate node N_{1,2} sends the second hash value, the requesting node's public key PK_{N1} and its own public key PK_{N1,2} to intermediate node N_{1,2,1} and intermediate node N_{1,2,2}. This process continues until the second hash value reaches the target node. For example, as shown in FIG. 23, intermediate node N_{1,1} forwards the second hash value, the requesting node's public key PK_{N1} and its own public key PK_{N1,1} to intermediate node N_{1,1,1} and the target node Nₖ. It will be appreciated that in practice there may be many more nodes in the P2P network and there may be many more rounds of intermediate nodes forwarding the second hash value, the received public keys and their own public key to other intermediate nodes until eventually the target node receives the second hash value.

A chain of nodes is formed from the requesting node to the target node. The chain is formed by the forwarding of the second hash value and public keys from the requesting node to the target node. The chain may be represented by the public keys received by the target node. For example, in FIG. 23 the chain is formed of the requesting node N₁, intermediate node N_{1,1} and the target node Nₖ, and is represented by public keys PK_{N1} and PK_{N1,1}. The requesting node is always at one end of the chain and the target node at the other end.

The requesting node may send the second hash value and its public key to the intermediate nodes via an off-chain channel, e.g. as part of the P2P network protocol. In other examples, the requesting node may send the second hash value and its public key to the intermediate nodes on-chain. That is, the requesting node may submit a request transaction to the blockchain, wherein the request transaction includes the second hash value and the requesting node's public key. The requesting node may also send the request transaction directly to the intermediate nodes via an off-chain channel. This improves performance as the nodes do not have to monitor the blockchain. The request transaction may include one or more outputs, wherein each output is locked to the respective public key of a respective intermediate node to which the requesting node is connected. For instance, if the requesting node is connected to three intermediate nodes, the request transaction may include three outputs, each locked to a respective intermediate node's public key.

Similarly, the intermediate nodes may forward the second hash value and the public keys via an off-chain channel of by submitting request transactions to the blockchain. Depending on how the second hash value and public keys are sent by the intermediate nodes, the target node either obtains the second hash value and public keys directly from an intermediate node (via an off-chain channel) or from the blockchain.

In some examples, the target node may recognise that the second hash value is associated with the target data item (or the target request), e.g. the second hash value may be included in a database mapped to the request. In other examples, the target node may have access to the first hash value (e.g. stored in a database mapped to the target request), receive the second hash value from the intermediate node, and verify that the first hash value hashes to the second hash value. If it does, the target node has the corresponding target request. In some examples, the second hash value may be obtained by hashing the first hash value with a timestamp. In these examples, the target node may try hashing the first value with a range of different time stamps to verify that the second hash is based on a known first hash value.

The target node uses the obtained public keys (i.e. the requesting node's public key and the respective public key of each other node in the chain) to encrypt the target data. That is, the target data is encrypted with each of the public keys, first with the requesting node's public key, then with the public key of the first intermediate node in the path, then with the public key of the second intermediate node in the path, and so on, until the target data has been encrypted with each public key. In some examples, the target data may first be split into one or more data packets, and each data packet may be encrypted with the set of public keys.

The data packet(s) encrypted with the set of public keys will be referred to as “final encrypted messages”. The data packet(s) encrypted with only the requesting node's public key will be referred to as “first encrypted messages”. That is, the data packets are each encrypted with the requesting nodes public key to obtain the first encrypted messages, and the first encrypted messages are each encrypted with the remaining public keys to obtain the final encrypted messages.

The target node sends the final encrypted message(s) to the final intermediate node in the path, i.e. the intermediate node that submitted the secondary request transaction having an output locked to the target node's public key. The final intermediate node decrypts the final encrypted message(s) using the private key corresponding to that node's public key in order to obtain a set of encrypted messages. Each of the encrypted message in the set of encrypted messages is encrypted with the public keys of the other intermediate nodes and the requesting node. The final intermediate node sends the set of encrypted messages to the next intermediate node in the path (in the direction of the requesting node) or, if there is only one intermediate node in the path, to the requesting node. Each intermediate node that receives a set of encrypted messages decrypts the messages with their respective private key and sends the resulting set of encrypted messages to the next node in the path. Eventually, the requesting node receives the one or more first encrypted messages. The requesting node may then decrypt the one or more first encrypted messages with its private key to obtain reveal the one or more data packets. The target data is then obtained by combining the data packets.

In some examples, the encrypted messages are submitted from node to node in one batch. In other examples, the encrypted messages are submitted from node to node one at a time.

The encrypted messages may be sent node to node via an off-chain channel. Alternatively, the encrypted message may be sent via the blockchain. E.g. each node may send one or more data transactions to the blockchain, wherein each data transaction comprises one or more encrypted messages.

The requesting node submits one or more attestation transaction to the blockchain to attest to the obtaining of the data packet(s). E.g. the attestation transaction may include a hash of the target data. The attestation transaction(s) may comprise an output locked to the public key of the node in the chain that send the first encrypted message(s) to the requesting node. The requesting node may submit a single attestation transaction to the blockchain, or a respective attestation transaction may be submitted for each data packet, e.g. each transaction may include a hash of a respective data packet. Similarly, each intermediate node may submit to one or more respective attestation transactions to the blockchain to attest to receiving the one or more encrypted messages from the previous node in the path. Additionally or alternatively, the target node may submit one or more attestation transactions to the blockchain to attest to the sending of the final encrypted messages to the node in the chain that is connected to the target node.

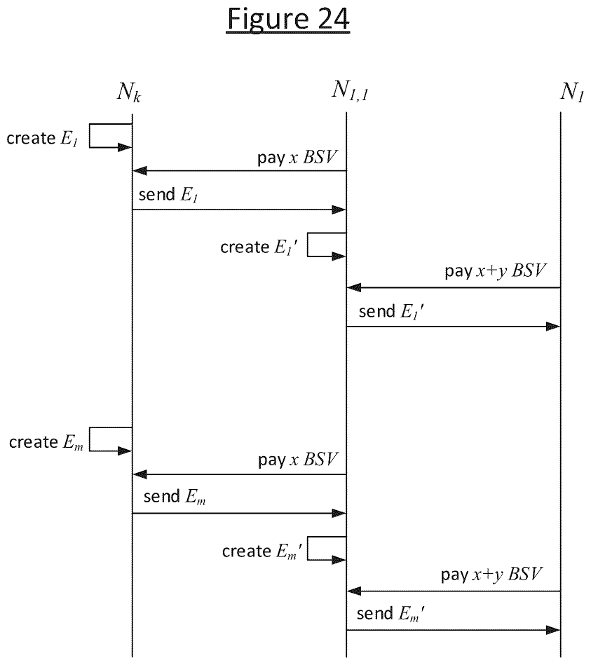

FIG. 24 illustrates the process of sending the encrypted messages to the requesting node via an intermediate node. As shown, the target node encrypts multiple data packets to obtain multiple encrypted messages. The encrypted messages are sent, one at a time, to the intermediate node. The intermediate node submits an attestation transaction to the blockchain network in return for, or in order to, receive the encrypted messages. The encrypted messages are decrypted using the intermediate node's private key to reveal the first encrypted messages. The first encrypted messages are then sent to the requesting node, which attests to the receiving of the first encrypted messages. The first encrypted messages are decrypted to reveal the target data.

In some examples, the target node may encrypt the target data (or respective chunks of the target data) together with the first hash value to generate the first encrypted message(s). That is, each data packet (whether it be the target data as a whole or a chunk thereof) is combined with the first hash value before being encrypted with the requesting node's public key. When decrypting the first encrypted message(s), the requesting node may verify that the decrypted first hash value is the correct first hash value upon which the second hash value was based. In this way, the requesting node can be sure that the data packet(s) have been provided by the target node, since the target node had access to the first hash value, e.g. by hashing the data request.

### 9. Example Implementation

The following provides example implementations of the flooding request embodiments and the chain request embodiments.

To add P2P data transfer incentives, nodes may attest each transfer on the blockchain using transactions which are then received by nodes involved in the transfer process. By using the blockchain network, an auditable trail of communications is created such that nodes that cheat may be held liable. FIG. 17 offers a visualisation of the transfer between nodes N₁ and N_{1,1}. Consider the source node N₁ requesting data D from the P2P network and assume the sink node Nₖ=N_{1,1,2} owns the data. The requested data can be a file, network query or proof of identity for example. To transfer it from Nₖ to N₁, there are two layers to the implementation:
Incentivise P2P network flooding of data requests.
Incentivise data distribution to the node requesting it.

Depending on the network, nodes can combine the two layers into a protocol that incentivises both request flooding and data distribution. It is assumed that each node has an associated public key through which it is uniquely identifiable in the P2P network.

### 9.1 Flooding Rewards

N₁ sends a request R for data D in the P2P network, attaching payment rewards for forwarding the request. Once the request reaches Nₖ, it transfers data D directly to N₁ for a payment reward. The protocol is split into a peer-discovery phase to find Nₖ (FIG. 18) and a settling phase for payment and data transfer (FIG. 19). The protocol is as follows.

### 9.1.1 Peer-Discovery Phase:

1. N₁ hashes its request R, H₁(H₀(R)) where H₁ and H₀ are hash functions, not necessarily different.
2. N₁ sends a transaction with locktime T₁ (FIG. 20) containing the hashed request H₁(H₀(R)) to its adjacent nodes N_{1,1}, N_{1,2}. N₁ spends an UTXO TxID_{N}_{₁}∥o.

If N₁ does not receive a response to its request before locktime T₁, it broadcasts a transaction with no locktime returning the funds to itself.
3. Each node N₁, forwards the request in the network by creating a transaction with locktime T_{2,i} (FIG. 21). N_{1,i} spends an UTXO TxID_{N}_{_{1,i}}∥o.

If N_{1,i} does not receive a response to its request before locktime T_{2,i}, it broadcasts a transaction with no locktime returning the funds to itself.
4. The sink node Nₖ receives H₁(H₀(R)) and recognises the request R (e.g. from a locally stored database). Nₖ broadcasts a message to the P2P network containing its identity and H₀(R).

### 9.1.2 Settling Phase:

5. When all nodes receive the broadcasted message containing H₀(R), nodes N_{1,i} spend the ith output of the transaction in FIG. 20, and nodes N_{1,i,j} spend the jth output of the transaction in FIG. 21. For example, Nₖ broadcasts transaction TxIDₐₙₛ-Nₖ as given in Error! Reference source not found. to the Bitcoin network.
6. Node N₁ receives H₀(R) and the identity of Nₖ revealed by step 4. N₁ contacts Nₖ.
7. Nₖ sends data D to N₁, e.g. using a payment channel protocol and receives a payment of y BSV.

The script [Hash-puzzle <H₁(H₀(R))>] is defined as:

$$OP\_SHA 256 < {H}_{1} ( {H}_{0} ( R ) ) > OP\_EQUALVERIFY$$

and fix H₁ as the hash function corresponding to the opcode OP_SHA256. The hash-puzzle can be unlocked with the script <H₀(R)>.

Node N₁ funds the transaction requests paying 2x BSV to each of its adjacent nodes N_{1,1} and N_{1,2}. In our network structure we consider only one hop to reach Nₖ, but the amount of 2x BSV should be chosen based on how fast the requests are to be answered and how many hops are expected. N_{1,1} and N_{1,2} cannot receive the payment unless they know H₀(R) and thus, they are incentivised to forward H₁(H₀(R)) to their adjacent peers for a reward of x BSV.

Nₖ is incentivised to make H₀(R) public and broadcast it in the P2P network because this way it makes its identity known to N₁ and receives a payment for the data transfer. In total, Nₖ receives a payment of y BSV for the data transfer and a payment of x−∈ BSV by broadcasting TxIDₐₙₛ-Nₖ. Then, each node N_{1,1} and N_{1,2} make a profit of

$$2 x - x - ϵ = x - ϵ BSV$$

Similarly, N_{1,1,1}, N_{1,2,1}, N_{1,2,2} make a profit of x−∈ BSV by Step 5. The table below summarises the incentives:

| Nodes | Incentive |
|---|---|
| N₁ | receive data D |
| N_{1, 1}, N_{1, 2}, N_{1, 1, 1}, N_{1, 2, 1}, N_{1, 2, 2} | x − ∈ BSV |
| Nₖ | y + x − ∈ BSV |

There may be a setting where N_{1,2} cheats, waiting for H₀(R) to be broadcasted by Nₖ and receiving 2x BSV without forwarding the request. This scenario should be avoided by N₁, since by not following the protocol N_{1,2} is reducing the chances for data D to be found. Thus, N₁ is incentivised to routinely check on the blockchain if its adjacent peers forwarded the request by relaying transactions. If any of them do not forward the request, N₁ can lower its rewards for the dishonest peers or force them to disconnect from the network by contacting the Certificate Authority, as described above in sections 6 and 7.

Similarly, N_{1,2} can pay less than x BSV to its peers, lowering the incentive to forward the request. As in the case above, N₁ can routinely check on the blockchain the payments of N_{1,2} and lower future rewards or disconnect it from the network.

An additional discussion point relates to the request R. If nodes want to cheat and retrieve the request reward without waiting for Nₖ to be found, they have to brute-force H₁(H₀(R)) in order to find H₀(R). If R is long then such an approach may be too expensive. The hawk-eyed reader can also notice that, as currently written, the protocol has a vulnerability. A request R can be sent multiple times though the network, not necessarily by the same source node N₁. In this case nodes may act dishonestly: knowing H₀(R) from the first request, nodes can spend the transactions in step 2. One mitigation to this problem is for N₁ to append a time variable to H₀(R) such as the Unix time value unixtime:

$${H}_{0} ( R ) \vert \vert unixtime$$

and create the transactions using the hash H₁(H₀(R)∥unixtime). When Nₖ receives the request, it should check for values close to the current Unix time in order to match the request. This adds a small burden on Nₖ to find the correct Unix time value and the request R in its database.

### 9.2 Chain Rewards

In the flooding reward section N₁ contacted Nₖ directly to receive the data. In this section, however, the data D is being propagated through the network path connecting Nₖ to N₁-we call such a path the winning chain. Only the nodes on the winning chain are rewarded and to securely transfer the data D through the chain from Nₖ to N₁, we need to encrypt it. FIGS. 23 and 24 offer a visualisation of the communication.

### 9.2.1 Peer-Discovery Phase:

1. N₁ sends H₁(H₀(R)) and its public key PK_{N}_{₁} to each adjacent nodes N_{1,i}.
2. After receiving H₁(H₀(R)) and PK_{N}_{₁}, N_{1,i} further sends H₁(H₀(R)) together with PK_{N}_{₁} and PK_{N}_{_{1,i}} to each adjacent nodes PK_{N}_{_{1,i,j}}.
3. N_{1,i,j} receives H₁(H₀(R)) and PK_{N}_{₁}, PK_{N}_{_{1,i}}.

By executing the peer-discovery steps 1-3, Nₖ receives H₁(H₀(R)) together with the public keys N₁ and N_{1,1} and hence the winning chain Nₖ, N_{1,1}, N₁ is formed. The protocol for settling the payments for the chain is as follows.

### 9.2.2 Settling Phase:

4. Nₖ splits data D into m data packets Dᵢ, 1≤i≤m. For example if data D has size 128 kb, Nₖ can split it into m=4 packets Dᵢ each of size 32 kb.
For each data packet Dᵢ execute:
5. Nₖ encrypts the data packet Dᵢ:

$${E}_{i} = E n {c}_{P {K}_{{N}_{1 , 1}}} ( {H}_{0} ( R ) \vert \vert {Enc}_{P {K}_{{N}_{1}}} ( {H}_{0} ( R ) \vert \vert {D}_{i} ) )$$

6. Nₖ sends Eᵢ to N_{1,1} and N_{1,1} pays Nₖ a reward of x BSV through a Bitcoin transaction.
7. Once N_{1,1} receives Eᵢ from Nₖ, it decrypts the encrypted data Eᵢ using the private key associated with PK_{N}_{_{1,1}} to obtain

$${H}_{0} ( R ) \vert \vert En {c}_{P {K}_{{N}_{1}}} ( {H}_{0} ( R ) \vert \vert {D}_{i} )$$

N_{1,1} checks its validity by hashing H₀(R): H₁(H₀(R)), verifying the request. If validation fails, the process stops.
8. N_{1,1} extracts the encrypted data destined to N₁:

$${E}_{i}^{′} = {Enc}_{P {K}_{{N}_{1}}} ( {H}_{0} ( R ) \vert \vert {D}_{i} )$$

9. N_{1,1} sends Eᵢ′ to N₁ and N₁ pays N_{1,1} a reward of x+y BSV through a Bitcoin transaction.
10. N₁ decrypts Et using the private key associated with PK_{N}_{₁} to obtain

$${H}_{0} ( R ) \vert \vert {D}_{i}$$

N₁ checks the validity by hashing H₀(R): H₁(H₀(R)), verifying the request. If validation fails, the process stops.
11. Return to step 5 and retrieve the next data packet.

The table below summarises the incentives for each node:

| Node | Incentive per data packet |
|---|---|
| Nₖ | x BSV |
| N_{1, 1} | y BSV |
| N₁ | receiving the data packet Dᵢ |

The justification for N_{1,1}'s incentive is the following: N_{1,1} pays x BSV to Nₖ in step 6, and N_{1,1} receives y+x BSV from N₁ in step 9. Thus, the profit margin of N_{1,1} is y BSV for each data packet.

The following explains how the encryption format prevents cheating:
Prepended hash: In case N₁ makes multiple requests for data in the P2P network, each encrypted data Eᵢ and Eᵢ′ contains H₀(R). This way N_{1,1} and N₁ know to which request is the encrypted data associated to.
Encryption layers: Since Nₖ encrypts each packet Dᵢ with both PK_{N}_{₁} and PK_{N}_{_{1,1}} in step 5, this prevents N₁ from cheating N_{1,1} as follows. If Nₖ encrypted the data packet Dᵢ only with PK_{N}_{₁}:

$$E n {c}_{P {K}_{{N}_{1}}} ( {H}_{0} ( R ) \vert \vert {D}_{i} )$$

then N₁ can obtain and decrypt the data addressed to N_{1,1} by eavesdropping on the connection between Nₖ and N_{1,1}. In this case, N_{1,1} pays for the encrypted data packet, but when sending it to N₁, N₁ will refuse to pay since it has already acquired the packet Dᵢ.

If Nₖ encrypts each packet Dᵢ with both PK_{N}_{₁} and PK_{N}_{_{1,1}}, then N₁ will not be able to gain any information from the encrypted data

$$E n {c}_{P {K}_{{N}_{1 , 1}}} ( {H}_{0} ( R ) \vert \vert En {c}_{P {K}_{{N}_{1}}} ( {H}_{0} ( R ) \vert \vert {D}_{i} ) )$$

if it eavesdrops.

Checking the data quality and matching the quality required by N₁ to the one received from Nₖ is a difficult problem [7]. Our system implements some protection for N_{1,1} and N₁: if Nₖ behaves dishonestly and the data quality is not appropriate, it can trick N_{1,1} and N₁ to pay for at most one invalid data packet Dᵢ, with subsequent data packets and payments being refused to Nₖ.

In case of a data quality mismatch, N_{1,1}, being the adjacent peer of Nₖ, can lower subsequent payments having public proof on the blockchain that Nₖ cheated. If cheating continues, then N_{1,1} can report Nₖ to the Certificate Authority and disconnect it from the network.

A node is said to duplicate its identity if they use multiple IP addresses and associated identity certificates throughout the network, thus appearing as different entities. Through a Sybil attack, a node can duplicate its identity in an attempted to gain more reward. The impact of such attacks have on the chain reward protocol is that cheating nodes can bloat the fees by sending the data to their fake identities. This may be prevented by requiring that the Certificate Authority will not issue different identities to the same node at the network setup phase.

No honest node is incentivised to accept a connection from a node without a certificate since this potentially leads to increasing the rewards it pays. A cheating node can only duplicate their presence in the network by attaching copies to themselves. Assume that in our P2P network N_{1,1} cheats leading to the winning chain: Nₖ, N_{1,1}, N_{1,1}, N₁. By performing this attack, N_{1,1} increases the reward it receives from N₁ by convincing it that the winning chain was longer.

Because all transactions are recorded on the blockchain, N₁ can check if N_{1,1} has been duplicating itself along the winning chain and refuse payment. Moreover, it is easy for node Nₖ to check for duplicate public keys it receives in step 3. The sink node may be liable for dishonest behaviour if it does not check for duplicate identities, hence taking part in a dishonest scheme.

### 9.3 Flooding and Chain Rewards

The protocols of sections 9.1 and 9.2 can be combined into an incentive mechanism for request and data propagation in the P2P network:
Peer-discovery: starting from N₁, execute steps 1-4 given in section 9.1
Settling: once the request reaches Nₖ, execute steps 4-11 given in section Error! Reference source not found.

This protocol improves the protocols in sections 9.1 and 9.2 as follows:
Because in section 9.1 the data D was transferred from Nₖ to N₁ outside the P2P network structure, Nₖ and N₁ have to use a different infrastructure on which there may be data transfer delays. In the existing P2P network structure, however, N₁ can estimate delays by adding locktimes on its request transactions. Hence, by transferring the data using the settling phase of the protocol of section 9.2, we add a control on transfer delays.
In the protocol of section 9.2, the node N_{1,2} is not part of the winning chain and it may stop forwarding future requests. Since the requests are not attested to the blockchain, N₁ cannot prove that N_{1,2} is not following the protocol. Thus, by offering flooding rewards, we incentivise N_{1,2} to forward requests.

### 10. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer implemented method of using a blockchain to coordinate data transfer over a peer-to-peer, P2P, network, wherein the P2P network comprises a plurality of P2P nodes, wherein each P2P node is connected to at least one other P2P node and is associated with a respective public key, wherein a target one of the P2P nodes has access to a target data item, and wherein the method is performing by a requesting P2P node and comprises:
obtaining a second hash value, wherein the second hash value is generated by hashing at least a data request with a first hash function to generate a first hash value and then hashing at least the first hash value with a second hash function to generate the second hash value, wherein the data request is associated with the target data item;
sending the second hash value and the requesting P2P node's public key to one or more P2P nodes connected to the requesting P2P node, wherein a chain of P2P nodes is formed between the requesting P2P node and the target P2P node, each P2P node in the chain being connected to a previous P2P node in the chain and/or a next P2P node in the chain, and wherein each P2P node in the chain is configured to send, to the next P2P node in the chain, the second hash value and the respective public key associated with each respective previous P2P node in the chain, such that the target P2P node receives the second hash value and one or more respective public keys;
wherein the target P2P node is configured to split the target data item into one or more respective data packets, use the requesting P2P node's public key to encrypt each of the one or more respective data packets together with the first hash value to generate one or more respective first encrypted messages, and generate one or more respective final encrypted messages by encrypting the one or more respective first encrypted messages with each of the received one or more respective public keys, and wherein the method comprises:
obtaining the one or more first encrypted messages from the respective P2P node in the chain connected to the requesting P2P node, wherein each respective P2P node in the chain other than the requesting P2P node obtains one or more encrypted messages from the next respective P2P node in the chain, decrypts the one or more encrypted messages using the respective private key associated with the respective P2P node, and sends the one or more encrypted messages to the previous respective P2P node in the chain, such that the one or more final encrypted messages are successively decrypted as they are sent along the chain from the target P2P node to the requesting P2P node;
decrypting the one or more respective first encrypted messages to obtain the one or more respective data packets and constructing the target data item based thereon; and
submitting one or more respective attestation transactions to the blockchain network to attest to obtaining the one or more first encrypted messages from the respective P2P node in the chain connected to the requesting P2P node.

Statement 2. The method of statement 1, wherein each P2P node in the chain that obtains one or more encrypted messages from the next respective P2P node in the chain is configured to submit one or more respective attestation transactions to the blockchain network to attest to obtaining the one or more encrypted messages from the respective next P2P node in the chain.

Statement 3. The method of statement 1 or statement 2, wherein decrypting each respective first encrypted messages reveals a candidate first hash value and the respective data packet, and wherein the method comprises:
hashing the candidate first hash value with the second hash function to generate a candidate second hash value; and
verifying that that the candidate second hash value matches the second hash value.

Statement 4. The method of any preceding statement, wherein said sending of the second hash value to the one or more P2P nodes connected to the requesting P2P node comprises sending the second hash value directly to the one or more P2P nodes.

Statement 5. The method of any of statements 1 to 4, wherein said sending of the second hash value to the one or more P2P nodes connected to the requesting P2P node comprises submitting a request transaction to the blockchain network, wherein the request transaction comprises the second hash value and one or more respective outputs, each respective output being locked to the respective public key of a respective one of the P2P nodes.

Statement 6. The method of any preceding statement, wherein the target data item is split into a plurality of data packets.

Statement 7. The method of any preceding statement, wherein said obtaining of the one or more first encrypted messages from the respective P2P node comprises obtaining the one or more first encrypted messages directly from the respective P2P node.

Statement 8. The method of any preceding statement, wherein the blockchain comprises one or more respective data transactions, each respective data transaction comprising a respective first encrypted message, and wherein said obtaining of the one or more first encrypted messages from the respective P2P node comprises obtaining the one or more first encrypted messages from the blockchain.

Statement 9. The method of any preceding statement, wherein said obtaining of the second hash value comprises generating the second hash value.

Alternatively, the second hash function may be obtained from a different P2P node or a trusted third party.

Statement 10. The method of any preceding statement, wherein the first and second hash functions are the same hash function.

Statement 11. The method of any of statements 1 to 9, wherein the first and second hash functions are different hash functions.

Statement 12. The method of any preceding statement, wherein the first hash function is a cryptographic hash function and/or the second hash function is a cryptographic hash function.

Statement 13. The method of any preceding statement, wherein the data request is based on a hash of the target data item.

Statement 14. A computer implemented method of using a blockchain to coordinate data transfer over a peer-to-peer, P2P, network, wherein the P2P network comprises a plurality of P2P nodes, wherein each P2P node is connected to at least one other P2P node and is associated with a respective public key, wherein a target one of the P2P nodes has access to a target data item requested by a requesting P2P node, wherein the method is performing by the target P2P node and comprises:
obtaining a second hash value and one or more public keys, each public key being associated with a respective P2P node, wherein one of the one or more public keys is the requesting P2P node's public key, and wherein each of the other one or more public keys is associated with a respective P2P node belonging to a chain of P2P nodes between the requesting p2P node and the target P2P node, each P2P node in the chain being connected to a previous P2P node in the chain and/or a next P2P node in the chain;
determining that the second hash value is based on a first hash value, wherein the first hash value is based on a data request associated with the target data item;
splitting the target data item into one or more respective data packets;
using the requesting P2P node's public key to encrypt each of the one or more respective data packets together with the first hash value to generate one or more respective first encrypted messages;
encrypting the one or more respective first encrypted messages with each of the respective public keys associated with the respective P2P nodes in the chain to generate one or more respective final encrypted messages; and
sending the one or more respective final encrypted messages to the P2P node in the chain that is connected to the target P2P node, and wherein one or more respective attestation transactions are submitted to the blockchain network to attest to the sending of the one or more respective final encrypted messages.

Statement 15. The method of statement 14, wherein the one or more respective attestation transactions are submitted to the blockchain network are submitted to the blockchain network by the target P2P node.

Statement 16. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 15.

Statement 17 A computer program embodied on computer-readable storage and configured so as, when run on one or more processors, to perform the method of any of statements 1 to 15.

According to another aspect disclosed herein, there may be provided a method comprising the actions of the requesting P2P node and the target P2P node.

According to another aspect disclosed herein, there may be provided a system comprising the computer equipment of the requesting P2P node and the target P2P node.

1. A computer implemented method of using a blockchain to coordinate data transfer over a peer-to-peer, P2P, network, wherein the P2P network comprises a plurality of P2P nodes, wherein each P2P node is connected to at least one other P2P node and is associated with a respective public key, wherein a target one of the P2P nodes has access to a target data item, and wherein the method is performing by a requesting P2P node and comprises:
obtaining a second hash value, wherein the second hash value is generated by hashing at least a data request with a first hash function to generate a first hash value and then hashing at least the first hash value with a second hash function to generate the second hash value, wherein the data request is associated with the target data item;
sending the second hash value and the requesting P2P node's public key to one or more P2P nodes connected to the requesting P2P node, wherein a chain of P2P nodes is formed between the requesting P2P node and the target P2P node, each P2P node in the chain being connected to a previous P2P node in the chain and/or a next P2P node in the chain, and wherein each P2P node in the chain is configured to send, to the next P2P node in the chain, the second hash value and the respective public key associated with each respective previous P2P node in the chain, such that the target P2P node receives the second hash value and one or more respective public keys;
wherein the target P2P node is configured to split the target data item into one or more respective data packets, use the requesting P2P node's public key to encrypt each of the one or more respective data packets together with the first hash value to generate one or more respective first encrypted messages, and generate one or more respective final encrypted messages by encrypting the one or more respective first encrypted messages with each of the received one or more respective public keys, and wherein the method comprises:
obtaining the one or more first encrypted messages from the respective P2P node in the chain connected to the requesting P2P node, wherein each respective P2P node in the chain other than the requesting P2P node obtains one or more encrypted messages from the next respective P2P node in the chain, decrypts the one or more encrypted messages using the respective private key associated with the respective P2P node, and sends the one or more encrypted messages to the previous respective P2P node in the chain, such that the one or more final encrypted messages are successively decrypted as they are sent along the chain from the target P2P node to the requesting P2P node;
decrypting the one or more respective first encrypted messages using the requesting P2P node's private key to obtain the one or more respective data packets and constructing the target data item based thereon; and
submitting one or more respective attestation transactions to the blockchain network to attest to obtaining the one or more first encrypted messages from the respective P2P node in the chain connected to the requesting P2P node.

2. The method of claim 1, wherein each P2P node in the chain that obtains one or more encrypted messages from the next respective P2P node in the chain is configured to submit one or more respective attestation transactions to the blockchain network to attest to obtaining the one or more encrypted messages from the respective next P2P node in the chain.

3. The method of claim 1, wherein decrypting each respective first encrypted messages reveals a candidate first hash value and the respective data packet, and wherein the method comprises:
hashing the candidate first hash value with the second hash function to generate a candidate second hash value; and
verifying that that the candidate second hash value matches the second hash value.

4. The method of claim 1, wherein said sending of the second hash value to the one or more P2P nodes connected to the requesting P2P node comprises sending the second hash value directly to the one or more P2P nodes.

5. The method of claim 1, wherein said sending of the second hash value to the one or more P2P nodes connected to the requesting P2P node comprises submitting a request transaction to the blockchain network, wherein the request transaction comprises the second hash value and one or more respective outputs, each respective output being locked to the respective public key of a respective one of the P2P nodes.

6. The method of claim 1, wherein the target data item is split into a plurality of data packets.

7. The method of claim 1, wherein said obtaining of the one or more first encrypted messages from the respective P2P node comprises obtaining the one or more first encrypted messages directly from the respective P2P node.

8. The method of claim 1, wherein the blockchain comprises one or more respective data transactions, each respective data transaction comprising a respective first encrypted message, and wherein said obtaining of the one or more first encrypted messages from the respective P2P node comprises obtaining the one or more first encrypted messages from the blockchain.

9. The method of claim 1, wherein said obtaining of the second hash value comprises generating the second hash value.

10. The method of claim 1, wherein the first and second hash functions are the same hash function.

11. The method of claim 1, wherein the first and second hash functions are different hash functions.

12. The method of claim 1, wherein the first hash function is a cryptographic hash function and/or the second hash function is a cryptographic hash function.

13. The method of claim 1, wherein the data request is based on a hash of the target data item.

14. A computer implemented method of using a blockchain to coordinate data transfer over a peer-to-peer, P2P, network, wherein the P2P network comprises a plurality of P2P nodes, wherein each P2P node is connected to at least one other P2P node and is associated with a respective public key, wherein a target one of the P2P nodes has access to a target data item requested by a requesting P2P node, wherein the method is performing by the target P2P node and comprises:
obtaining a second hash value and one or more public keys, each public key being associated with a respective P2P node, wherein one of the one or more public keys is the requesting P2P node's public key, and wherein each of the other one or more public keys is associated with a respective P2P node belonging to a chain of P2P nodes between the requesting p2P node and the target P2P node, each P2P node in the chain being connected to a previous P2P node in the chain and/or a next P2P node in the chain;
determining that the second hash value is based on a first hash value, wherein the first hash value is based on a data request associated with the target data item;
splitting the target data item into one or more respective data packets;
using the requesting P2P node's public key to encrypt each of the one or more respective data packets together with the first hash value to generate one or more respective first encrypted messages;
encrypting the one or more respective first encrypted messages with each of the respective public keys associated with the respective P2P nodes in the chain to generate one or more respective final encrypted messages; and
sending the one or more respective final encrypted messages to the P2P node in the chain that is connected to the target P2P node, and wherein one or more respective attestation transactions are submitted to the blockchain network to attest to the sending of the one or more respective final encrypted messages.

15. The method of claim 14, wherein the one or more respective attestation transactions are submitted to the blockchain network are submitted to the blockchain network by the target P2P node.

16. Computer equipment, comprising:
memory comprising one or more memory units; and
processing apparatus comprising one or more processing units, wherein the memory stores code arranged to run on the processing apparatus, the code being configured so as when run on the processing apparatus, the processing apparatus performs a method of using a blockchain to coordinate data transfer over a peer-to-peer, P2P, network, wherein the P2P network comprises a plurality of P2P nodes, wherein each P2P node is connected to at least one other P2P node and is associated with a respective public key, wherein a target one of the P2P nodes has access to a target data item, and wherein the method is performing by a requesting P2P node and comprises:
obtaining a second hash value, wherein the second hash value is generated by hashing at least a data request with a first hash function to generate a first hash value and then hashing at least the first hash value with a second hash function to generate the second hash value, wherein the data request is associated with the target data item;
sending the second hash value and the requesting P2P node's public key to one or more P2P nodes connected to the requesting P2P node, wherein a chain of P2P nodes is formed between the requesting P2P node and the target P2P node, each P2P node in the chain being connected to a previous P2P node in the chain and/or a next P2P node in the chain, and wherein each P2P node in the chain is configured to send, to the next P2P node in the chain, the second hash value and the respective public key associated with each respective previous P2P node in the chain, such that the target P2P node receives the second hash value and one or more respective public keys;
wherein the target P2P node is configured to split the target data item into one or more respective data packets, use the requesting P2P node's public key to encrypt each of the one or more respective data packets together with the first hash value to generate one or more respective first encrypted messages, and generate one or more respective final encrypted messages by encrypting the one or more respective first encrypted messages with each of the received one or more respective public keys, and wherein the method comprises:
obtaining the one or more first encrypted messages from the respective P2P node in the chain connected to the requesting P2P node, wherein each respective P2P node in the chain other than the requesting P2P node obtains one or more encrypted messages from the next respective P2P node in the chain, decrypts the one or more encrypted messages using the respective public key associated with the respective P2P node, and sends the one or more encrypted messages to the previous respective P2P node in the chain, such that the one or more final encrypted messages are successively decrypted as they are sent along the chain from the target P2P node to the requesting P2P node;
decrypting the one or more respective first encrypted messages to obtain the one or more respective data packets and constructing the target data item based thereon; and
submitting one or more respective attestation transactions to the blockchain network to attest to obtaining the one or more first encrypted messages from the respective P2P node in the chain connected to the requesting P2P node.

17. A computer program embodied on non-transitory computer-readable storage media and configured so as, when run on one or more processors, the one or more processors perform a method of using a blockchain to coordinate data transfer over a peer-to-peer, P2P, network, wherein the P2P network comprises a plurality of P2P nodes, wherein each P2P node is connected to at least one other P2P node and is associated with a respective public key, wherein a target one of the P2P nodes has access to a target data item, and wherein the method is performing by a requesting P2P node and comprises:
obtaining a second hash value, wherein the second hash value is generated by hashing at least a data request with a first hash function to generate a first hash value and then hashing at least the first hash value with a second hash function to generate the second hash value, wherein the data request is associated with the target data item;
sending the second hash value and the requesting P2P node's public key to one or more P2P nodes connected to the requesting P2P node, wherein a chain of P2P nodes is formed between the requesting P2P node and the target P2P node, each P2P node in the chain being connected to a previous P2P node in the chain and/or a next P2P node in the chain, and wherein each P2P node in the chain is configured to send, to the next P2P node in the chain, the second hash value and the respective public key associated with each respective previous P2P node in the chain, such that the target P2P node receives the second hash value and one or more respective public keys;
wherein the target P2P node is configured to split the target data item into one or more respective data packets, use the requesting P2P node's public key to encrypt each of the one or more respective data packets together with the first hash value to generate one or more respective first encrypted messages, and generate one or more respective final encrypted messages by encrypting the one or more respective first encrypted messages with each of the received one or more respective public keys, and wherein the method comprises:
obtaining the one or more first encrypted messages from the respective P2P node in the chain connected to the requesting P2P node, wherein each respective P2P node in the chain other than the requesting P2P node obtains one or more encrypted messages from the next respective P2P node in the chain, decrypts the one or more encrypted messages using the respective public key associated with the respective P2P node, and sends the one or more encrypted messages to the previous respective P2P node in the chain, such that the one or more final encrypted messages are successively decrypted as they are sent along the chain from the target P2P node to the requesting P2P node;
decrypting the one or more respective first encrypted messages to obtain the one or more respective data packets and constructing the target data item based thereon; and
submitting one or more respective attestation transactions to the blockchain network to attest to obtaining the one or more first encrypted messages from the respective P2P node in the chain connected to the requesting P2P node.
